(19) United States
(12) Patent Application Publication
(10) Pub. No.: US 2023/0384797 A1
(43) Pub. Date: Nov. 30, 2023

(54) SYSTEM AND METHOD FOR INBOUND AND OUTBOUND AUTONOMOUS VEHICLE OPERATIONS

(71) Applicant: TuSimple, Inc., San Diego, CA (US)

(72) Inventor: Leon Moore White, III, Fernandina Beach, FL (US)

(21) Appl. No.: 18/192,219

(22) Filed: Mar. 29, 2023

Related U.S. Application Data
(60) Provisional application No. 63/365,295, filed on May 25, 2022.

(51) Int. Cl. G05D 1/02; G05D 1/00

(52) U.S. Cl. CPC G05D 1/0291; G05D 1/0088; G05D 1/0274; G05D 1/0231

(57) ABSTRACT

A system comprises a fleet of autonomous vehicles, a terminal, and an autonomous freight network (AFN) management device. The AFN management device receives information indicating that an autonomous vehicle is inbound to the terminal. The AFN management device determines locations of objects within the terminal based on sensor data. The AFN management device determines landing instructions indicating to avoid the locations of objects detected from the sensor data. The AFN management device communicates the landing instructions to the autonomous vehicle. A control device associated with the autonomous vehicle determines a route to reach a landing pad within the terminal based on the landing instructions. The control device instructs the autonomous vehicle to travel along the route.

This application claims priority to U.S. Provisional Application No. 63/365,295 filed May 25, 2022, and titled “SYSTEM AND METHOD FOR INBOUND AND OUTBOUND AUTONOMOUS VEHICLE OPERATIONS,” which is incorporated herein by reference.

### TECHNICAL FIELD

The present disclosure relates generally to autonomous vehicles. More particularly, the present disclosure is related to a system and method for inbound and outbound autonomous vehicle operations.

### BACKGROUND

One aim of autonomous vehicle technology is to provide vehicles that can safely navigate with limited or no driver assistance. An autonomous vehicle may travel from a start location to a destination. There are several operations to be performed to receive an incoming autonomous vehicle at a given location and to prepare an outgoing autonomous vehicle to launch from the location. The efficiency of the operation of the autonomous vehicle depends, at least in part, on the inbound and outbound operations.

### SUMMARY

This disclosure recognizes various problems and previously unmet needs related to autonomous vehicle navigation, and more specifically to the lack of technology in efficiently establishing and utilizing resources to launch autonomous vehicles reliably from a location and receive autonomous vehicles at the location. For example, when an autonomous vehicle is arriving at a given location, there may be several operations that may need to be performed to reliably receive the autonomous vehicle. If not optimized, these operations incur delays in the inbound operation of autonomous vehicles. In another example, when an autonomous vehicle is leaving a given location for a trip, there may be several operations that may be needed to prepare the autonomous vehicle for the trip. If not optimized, these operations incur delays in the outbound operation of autonomous vehicles.

Certain embodiments of the present disclosure provide unique technical solutions to technical problems of current autonomous vehicle technologies, including those problems described above to reduce inbound and outbound delays, and to improve incoming and outgoing autonomous vehicle navigation to and from a given location. The present disclosure contemplates systems and methods for improving inbound and outbound operations for autonomous vehicles.

In an example scenario, an autonomous vehicle may be inbound to a terminal. There are several operations that need to be performed in order to improve the efficiency of the inbound navigation of the incoming autonomous vehicle. The autonomous vehicle may travel from an entrance of the terminal to a landing pad where the autonomous vehicle can stop and park. In some cases, a traveling path from the entrance of the terminal to the landing pad may be obstructed by one or more obstacles, such as technicians working at the terminal, other autonomous vehicles, animals, vehicle components, etc. In such cases, the traveling path of the autonomous vehicle may lead to potential hazards and accidents.

The disclosed system is configured to inform the control device of the autonomous vehicle about the locations of objects in the traveling path toward the landing pad. In other words, the disclosed system informs the control device of the autonomous vehicle about potential safety issues along its traveling path to the landing pad so that the autonomous vehicle can be navigated more efficiently and safely, and avoid such potential safety issues. In this way, the disclosed system improves the inbound autonomous vehicle navigation and reduces the delay in the inbound autonomous vehicle navigation.

In some cases, upon arrival at the terminal, one or more operations may need to be performed on the autonomous vehicle. For example, the autonomous vehicle may need to drop off its load, be provided with a service, e.g., fuel refilling, be provided with updated map data, be loaded with new cargo, and/or any other operation. If not optimized, these operations waste time and incur a delay in autonomous vehicle navigation inside the terminal and therefore in autonomous vehicle preparation for the next trip.

The disclosed system is configured to provide more efficient operations to reduce delays in autonomous vehicles navigation, offloading, and preparation for the next trip. For example, the system may implement an example assembly line for an autonomous vehicle to follow and oversee each operation in the assembly line to make sure each operation is performed efficiently and therefore does not incur delays. An example assembly line may include a pipeline from 1) a landing pad where an autonomous vehicle stops after a trip; 2) to a trailer drop off zone where a trailer of the autonomous vehicle is dropped off; 3) to a data communication zone where updated data is uploaded to the autonomous vehicle; 4) to a service zone where the autonomous vehicle is serviced; and 5) to a tractor staging area where a tractor of the autonomous vehicle is staged to indicate that it is ready for a next trip. As such, the disclosed system improves the overall operation of the autonomous freight network of autonomous vehicles operating out of a terminal.

In another example scenario, an autonomous vehicle may be outbound from the terminal. In outbound navigation, the autonomous vehicle may need to travel from a launch pad to exit the terminal. In some cases, the traveling path of the autonomous vehicle from the launch pad to the exit of the terminal may be obstructed by one or more obstacles, such as technicians working at the terminal, other autonomous vehicles, animals, vehicle components, etc. In such cases, the traveling path of the autonomous vehicle may lead to potential hazards and accidents.

The disclosed system is configured to inform the outbound autonomous vehicle about the locations of objects in a traveling path from the launch pad to exit the terminal. In other words, the disclosed system informs the control device of the autonomous vehicle about potential safety issues along its traveling path to exit the terminal so that the autonomous vehicle can be navigated more efficiently and safely, and avoid such potential safety issues. In this way, the disclosed system improves outbound autonomous vehicle navigation and reduces the delay in outbound autonomous vehicle navigation.

Accordingly, the disclosed system may be integrated into a practical application of improving the autonomous vehicle technology by improving the efficiency in the operation of the fleet of autonomous vehicles entering and exiting terminals, for example, by employing an assembly line (e.g., an example assembly line described above) for the autonomous vehicle to follow. Furthermore, the disclosed system may be integrated into an additional practical application of reducing the inbound and outbound delays of the autonomous vehicles entering and exiting terminals. Thus, as a result of the reduction in the inbound and outbound delays, the congestion of vehicles at the terminal, its entrance, and its exit is reduced as well. This, in turn, provides an additional practical application of providing a safer driving experience for autonomous vehicles and other vehicles at the terminal.

Furthermore, the disclosed system may be integrated into an additional practical application of providing a safer traveling path for an autonomous vehicle landing on a landing pad or launching from a launch pad. For example, by informing the autonomous vehicle about the locations of the objects and obstacles in the terminal and more specifically in its vicinity, a safer traveling path is determined for the autonomous vehicle to reach the prescribed landing pad, or to exit the terminal using the safer traveling path, where in determining the safer traveling path, the objects and obstacles are avoided. In this process, information from the sensors on the autonomous vehicle as well as information from the sensors disposed around the terminal are used in determining the locations of the objects and obstacles in the terminal. Therefore, a more comprehensive and more accurate map of the terminal (that include objects and obstacles) is determined and used in navigating the autonomous vehicle.

In one embodiment, a system comprises a fleet of autonomous vehicles, a terminal, and an autonomous fright network management device. The fleet of autonomous vehicles comprises a first autonomous vehicle, wherein the first autonomous vehicle is configured to travel along a predetermined route. The terminal comprises one or more dedicated zones and one or more sensors within a physical space. Each of the one or more dedicated zones is configured to facilitate a particular function for the first autonomous vehicle. The one or more dedicated zones comprise a landing pad shaped to accommodate the first autonomous vehicle. The landing pad is established by a set of boundary indicators disposed around the landing pad. Each of the one or more sensors is configured to detect objects within a detection range. The autonomous freight network management device is operably coupled with the fleet of autonomous vehicles. The autonomous freight network management device comprises a first processor configured to receive information that indicates the first autonomous vehicle is inbound to the terminal. The first processor receives first sensor data indicating the locations of objects within the terminal. The first processor determines, based at least in part upon the first sensor data, at least one location of at least one object that is in the traveling path of the first autonomous vehicle to the landing pad. The first processor determines landing instructions that comprise the at least one location of at least one object, wherein the landing instructions indicate to avoid the at least one location of at least one object. The first processor communicates the landing instructions to the first autonomous vehicle. The first autonomous vehicle comprises a control device that comprises a second processor configured to receive the landing instructions. The second processor determines, based at least in part upon the landing instructions, a first route for the first autonomous vehicle to take in order to reach the landing pad, wherein the first route is free of the at least one object. The second processor instructs the first autonomous vehicle to travel according to the first route.

Certain embodiments of this disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates an embodiment of a system configured to optimize inbound and outbound operations of autonomous vehicles entering and exiting a terminal;

FIG. 2 illustrates an example operational flow of the system of FIG. 1;

FIG. 3 illustrates an embodiment of a method for implementing an inbound operation for an autonomous vehicle entering a terminal;

FIG. 4 illustrates an embodiment of a method for implementing an outbound operation for an autonomous vehicle exiting from a terminal;

FIG. 5 illustrates a block diagram of an example autonomous vehicle configured to implement autonomous driving operations;

FIG. 6 illustrates an example system for providing autonomous driving operations used by the autonomous vehicle of FIG. 5; and

FIG. 7 illustrates a block diagram of an in-vehicle control computer included in the autonomous vehicle of FIG. 5.

### DETAILED DESCRIPTION

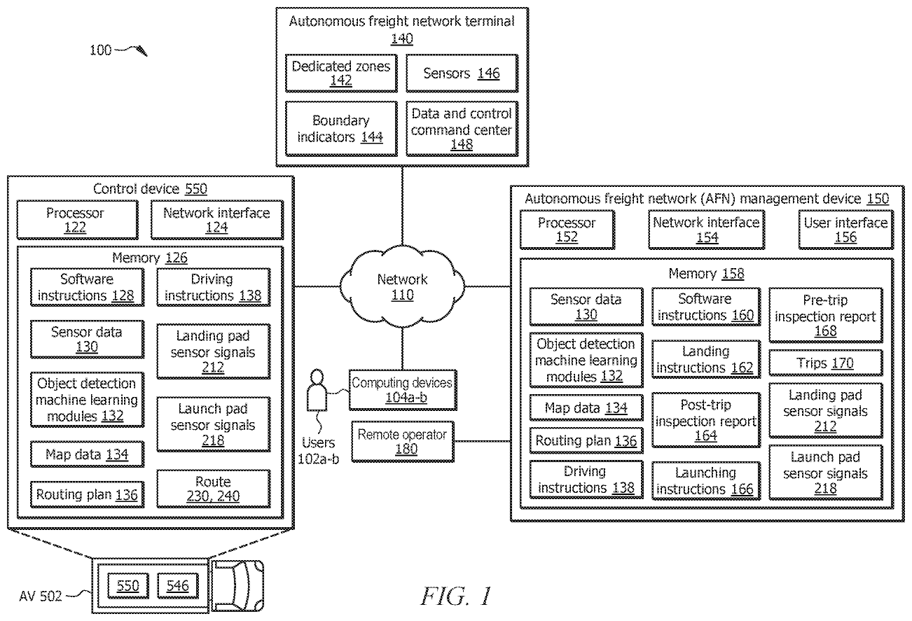

As described above, previous technologies fail to provide efficient, reliable, and safe solutions to implement inbound and outbound operations for autonomous vehicles entering and exiting a terminal. The present disclosure provides various systems, methods, and devices to implement inbound and outbound operations for autonomous vehicles entering and exiting a terminal to reduce or minimize inbound and outbound delays. Embodiments of the present disclosure and its advantages may be understood by referring to FIGS. 1 through 7. FIGS. 1 through 7 are used to describe a system and method to implement inbound and outbound operations for autonomous vehicles entering and exiting a terminal to reduce or minimize inbound and outbound delays.

### System Overview

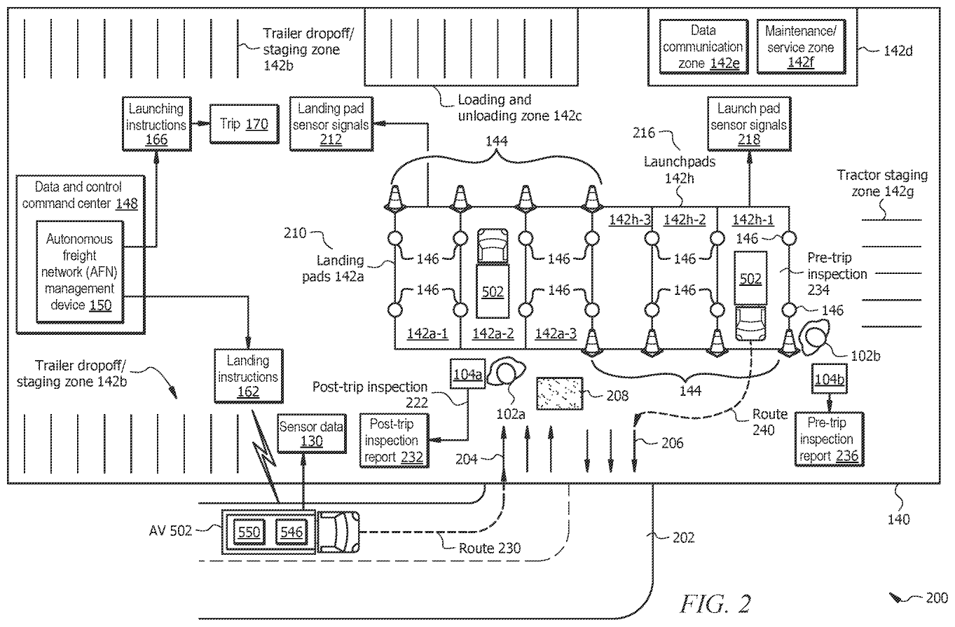

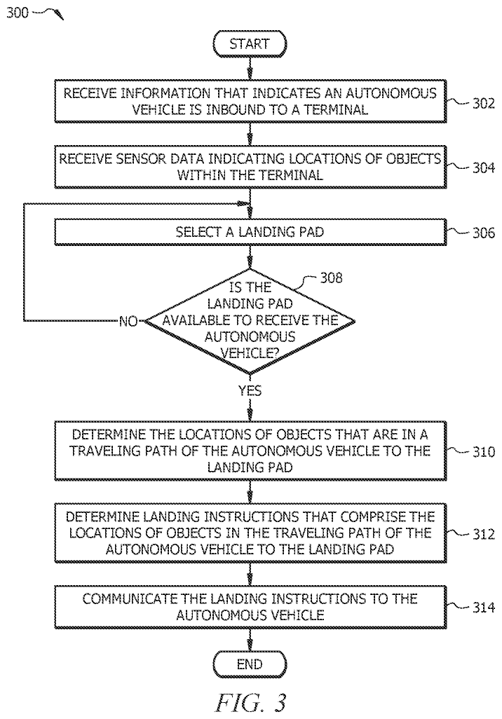

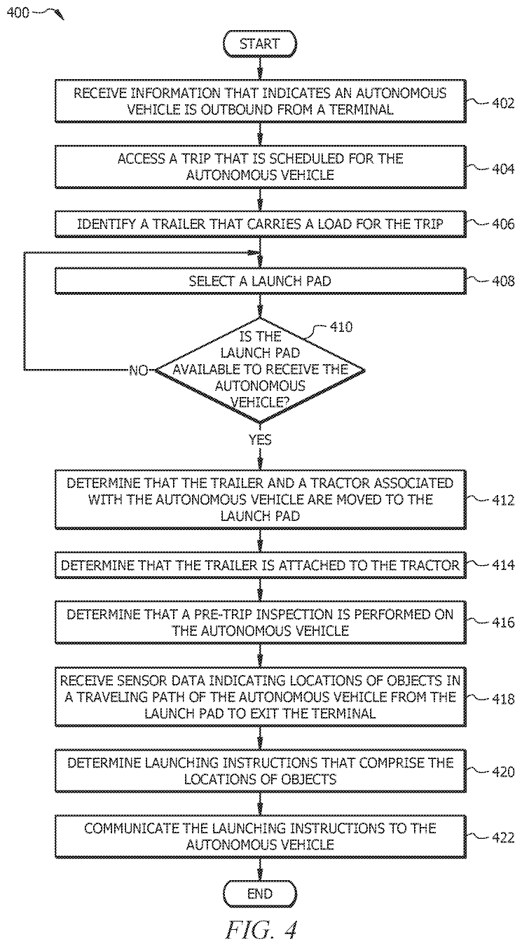

FIG. 1 illustrates an embodiment of an autonomous vehicle inbound and outbound management system 100 configured to optimize inbound and outbound operations of autonomous vehicles 502 entering and exiting a terminal 140. In certain embodiments, system 100 comprises an autonomous freight network (AFN) management device 150 communicatively coupled with an autonomous vehicle 502 and its components, including a control device 550 and sensors 146 associated with the terminal 140, and computing devices 104 associated with users 102 via network 110. Network 110 enables communications among components of system 100. The autonomous vehicle 502 comprises a control device 550. Control device 550 comprises a processor 122 in signal communication with a memory 126. Memory 126 stores software instructions 128 that when executed by the processor 122, cause the control device 550 to perform one or more operations described herein. AFN management device 150 comprises a processor 152 in signal communication with a memory 158. Memory 158 stores software instructions 160 that when executed by the processor 152, cause the AFN management device 150 to perform one or more operations described herein. For example, when the AFN management device 150 determines that an autonomous vehicle 502 is inbound to terminal 140, the software instructions 160 are executed to generate landing instructions 162 for the inbound or incoming autonomous vehicle 502. In another example, when the AFN management device 150 determines that an autonomous vehicle 502 is outbound from the terminal 140, the software instructions 160 are executed to generate launching instructions 166 for the outbound or outgoing autonomous vehicle 502. The landing instructions 162 are determined to optimize the landing and inbound autonomous vehicle 502 navigation, and reduce inbound autonomous vehicle 502 navigation delay. The launching instructions 166 are determined to optimize the launch and outbound autonomous vehicle 502 navigation and reduce outbound autonomous vehicle 502 navigation delay. These operations are described in greater detail in the operational flow 200 of system 100 described in FIG. 2 and methods 300 and 400 of system 100 described in FIGS. 3 and 4, respectively. In other embodiments, system 100 may not have all of the components listed and/or may have other elements instead of, or in addition to, those listed above. System 100 may be configured as shown or in any other configuration.

In an example scenario, an autonomous vehicle 502 may be inbound to the terminal 140. There are several operations that need to be performed in order to improve the efficiency of the inbound navigation of the incoming autonomous vehicle 502. The autonomous vehicle 502 may travel from an entrance of the terminal 140 to a landing pad 142a (see FIG. 2) where the autonomous vehicle can stop and park. In some cases, a traveling path of the autonomous vehicle 502 from the entrance of the terminal 140 to the landing pad 142a (see FIG. 2) may be obstructed by one or more obstacles, such as technicians working at the terminal 140, other autonomous vehicles 502, animals, vehicle components, etc. In such cases, the traveling path of the autonomous vehicle 502 may lead to potential hazards and accidents. The system 100 (e.g., via the AFN management device 150) is configured to inform the autonomous vehicle 502 about the locations of objects in a traveling path toward the landing pad 142a (see FIG. 2). In other words, the system 100 informs the control device 550 of the autonomous vehicle 502 about potential safety issues along its traveling path to the landing pad 142a (see FIG. 2) so that the control device 550 may navigate the autonomous vehicle 502 more efficiently and safely, and to avoid such potential safety issues.

In certain embodiments, the control device 550 of the autonomous vehicle 502 may use sensor data 130 captured by sensors 546 and the information received from the AFN management device 150 to determine a route to reach the landing pad 142a (see FIG. 2) that is free of obstructions. In this way, the inbound autonomous vehicle 502 navigation is optimized and the delay in the inbound autonomous vehicle 502 navigation is reduced.

In some cases, upon arrival at terminal 140, one or more operations may need to be performed on the autonomous vehicle 502. For example, the autonomous vehicle 502 may need to drop off its load, be provided with a service, e.g., fuel refilling, be provided with updated map data 134 and/or software instructions 128, be loaded with a new load, and/or any other operations. If not optimized, these operations waste time and incur a delay in autonomous vehicle 502 navigation inside the terminal 140 and autonomous vehicle preparation for the next trip.

The system 100 (e.g., via the AFN management device 150) is configured to provide more efficient operations to reduce delays in autonomous vehicles off loading and preparations for next trips. For example, the system 100 may implement an example assembly line for an autonomous vehicle 502 to follow. An example assembly line may include a pipeline from a landing pad 142a (see FIG. 2) to a loading and unloading zone 142c (see FIG. 2) to a trailer drop off zone 142b (see FIG. 2) to a data communication zone 142e (see FIG. 2) to a service zone 142f (see FIG. 2) to a tractor staging zone 142g (see FIG. 2) to a launch pad 142h (see (FIG. 2). In other examples, the assembly line may include any and any number of these operations in any suitable sequence. As such, the system 100 improves the overall operations of autonomous freight network of autonomous vehicles 502.

In another example scenario, an autonomous vehicle 502 may be outbound from the terminal 140. In the outbound autonomous vehicle 502 navigation, the autonomous vehicle 502 may need to travel from a launch pad 142h (see FIG. 2) to exit the terminal 140. In some cases, a traveling path of the autonomous vehicle 502 from the launch pad 142h (see FIG. 2) to the exit the terminal 140 may be obstructed by one or more obstacles, such as technicians working at the terminal 140, other autonomous vehicles 502, animals, vehicle components, etc. In such cases, the traveling path of the autonomous vehicle 502 may lead to potential hazards and accidents.

The system 100 (e.g., via the AFN management device 150) is configured to inform the autonomous vehicle 502 about the locations of objects and obstacles in a traveling path from the launch pad 142h (see FIG. 2) to exit the terminal 140. In other words, the system 100 informs the control device 550 of the autonomous vehicle 502 about potential safety issues along its traveling path to exit the terminal 140 so that the control device 550 may navigate the autonomous vehicle 502 more efficiently and safely, and avoid such potential safety issues.

In certain embodiments, the autonomous vehicle 502 may use sensor data 130 captured by sensors 546 and the information received from the AFN management device 150 to determine a route to exit the terminal 140 that is free of obstructions. In this way, the inbound autonomous vehicle 502 navigation is optimized and the delay in the inbound autonomous vehicle navigation is reduced. Thus, the system 100 improves the autonomous vehicle 502 inbound and outbound autonomous vehicle navigations.

### System Components

Network 110 may include any interconnecting system capable of transmitting audio, video, signals, data, messages, or any combination of the preceding. Network 110 may include all or a portion of a local area network (LAN), a wide area network (WAN), a metropolitan area network (MAN), a personal area network (PAN), a wireless PAN (WPAN), an overlay network, a software-defined network (SDN), a virtual private network (VPN), a packet data network (e.g., the Internet), a mobile telephone network (e.g., cellular networks, such as 4G or 5G), a plain old telephone (POT) network, a wireless data network (e.g., WiFi, WiGig, WiMax, etc.), a long-term evolution (LTE) network, a universal mobile telecommunications system (UMTS) network, a peer-to-peer (P2P) network, a Bluetooth network, a near-field communication (NFC) network, a Zigbee network, a Z-wave network, a WiFi network, and/or any other suitable network.

### Example Autonomous Vehicle

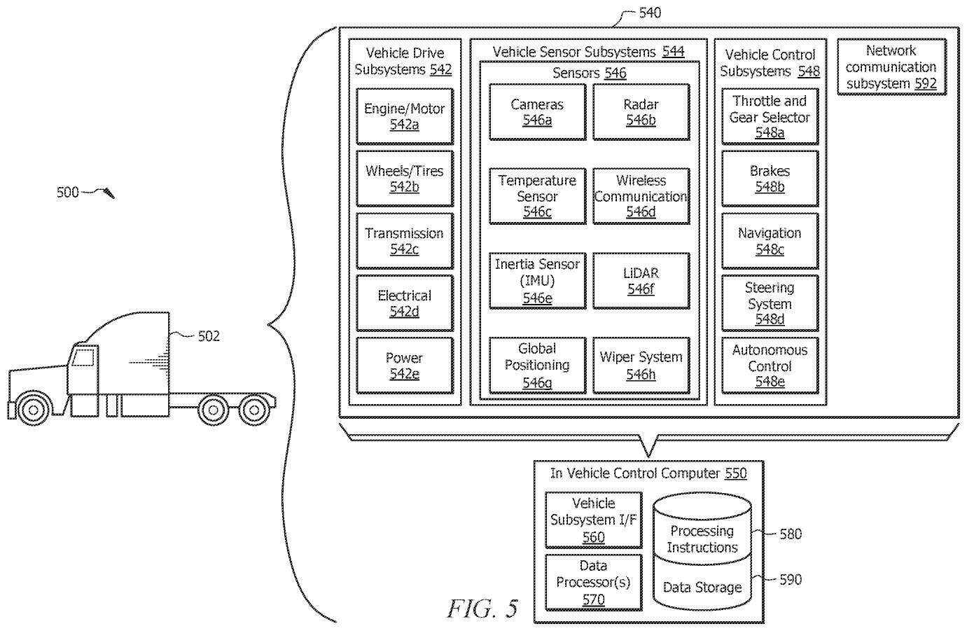

In one embodiment, the autonomous vehicle 502 may include a semi-truck tractor unit attached to a trailer to transport cargo or freight from one location to another location (see FIG. 5). The autonomous vehicle 502 is generally configured to travel along a road in an autonomous mode. The autonomous vehicle 502 may navigate using a plurality of components described in detail in FIGS. 5-7. The operation of the autonomous vehicle 502 is described in greater detail in FIGS. 5-7. The corresponding description below includes brief descriptions of certain components of the autonomous vehicle 502.

Control device 550 may be generally configured to control the operation of the autonomous vehicle 502 and its components and to facilitate autonomous driving of the autonomous vehicle 502. The control device 550 may be further configured to determine a pathway in front of the autonomous vehicle 502 that is safe to travel and free of objects or obstacles, and navigate the autonomous vehicle 502 to travel in that pathway. This process is described in more detail in FIGS. 5-7. The control device 550 may generally include one or more computing devices in signal communication with other components of the autonomous vehicle 502 (see FIG. 5). In this disclosure, the control device 550 may interchangeably be referred to as an in-vehicle control computer 550.

The control device 550 may be configured to detect objects on and around a road traveled by the autonomous vehicle 502 by analyzing the sensor data 130 and/or map data 134. For example, the control device 550 may detect objects on and around the road by implementing object detection machine learning modules 132. The object detection machine learning modules 132 may be implemented using neural networks and/or machine learning algorithms for detecting objects from images, videos, infrared images, point clouds, radar data, etc. The object detection machine learning modules 132 are described in more detail further below. The control device 550 may receive sensor data 130 from the sensors 546 positioned on the autonomous vehicle 502 to determine a safe pathway to travel. The sensor data 130 may include data captured by the sensors 546.

Sensors 546 may be configured to capture any object within their detection zones or fields of view, such as landmarks, lane markers, lane boundaries, road boundaries, vehicles, pedestrians, and road/traffic signs, among others. In some embodiments, the sensors 546 may be configured to detect rain, fog, snow, and/or any other weather condition. The sensors 546 may include a detection and ranging (LiDAR) sensor, a radar sensor, a video camera, an infrared camera, an ultrasonic sensor system, a wind gust detection system, a microphone array, a thermocouple, a humidity sensor, a barometer, an inertial measurement unit, a positioning system, an infrared sensor, a motion sensor, a rain sensor, and the like. In some embodiments, the sensors 546 may be positioned around the autonomous vehicle 502 to capture the environment surrounding the autonomous vehicle 502. See the corresponding description of FIG. 5 for further description of the sensors 546.

### Control Device

The control device 550 is described in greater detail in FIG. 5. In brief, the control device 550 may include the processor 122 in signal communication with the memory 126 and a network interface 124. The processor 122 may include one or more processing units that perform various functions as described herein. The memory 126 may store any data and/or instructions used by the processor 122 to perform its functions. For example, the memory 126 may store software instructions 128 that when executed by the processor 122 causes the control device 550 to perform one or more functions described herein.

The processor 122 may be one of the data processors 570 described in FIG. 5. The processor 122 comprises one or more processors operably coupled to the memory 126. The processor 122 may be any electronic circuitry, including state machines, one or more central processing unit (CPU) chips, logic units, cores (e.g., a multi-core processor), field-programmable gate arrays (FPGAs), application-specific integrated circuits (ASICs), or digital signal processors (DSPs). The processor 122 may be a programmable logic device, a microcontroller, a microprocessor, or any suitable combination of the preceding. The processor 122 may be communicatively coupled to and in signal communication with the network interface 124 and memory 126. The one or more processors may be configured to process data and may be implemented in hardware or software. For example, the processor 122 may be 8-bit, 16-bit, 32-bit, 64-bit, or of any other suitable architecture. The processor 122 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The one or more processors may be configured to implement various instructions. For example, the one or more processors may be configured to execute software instructions 128 to implement the functions disclosed herein, such as some or all of those described with respect to FIGS. 1-7. In some embodiments, the function described herein is implemented using logic units, FPGAs, ASICs, DSPs, or any other suitable hardware or electronic circuitry.

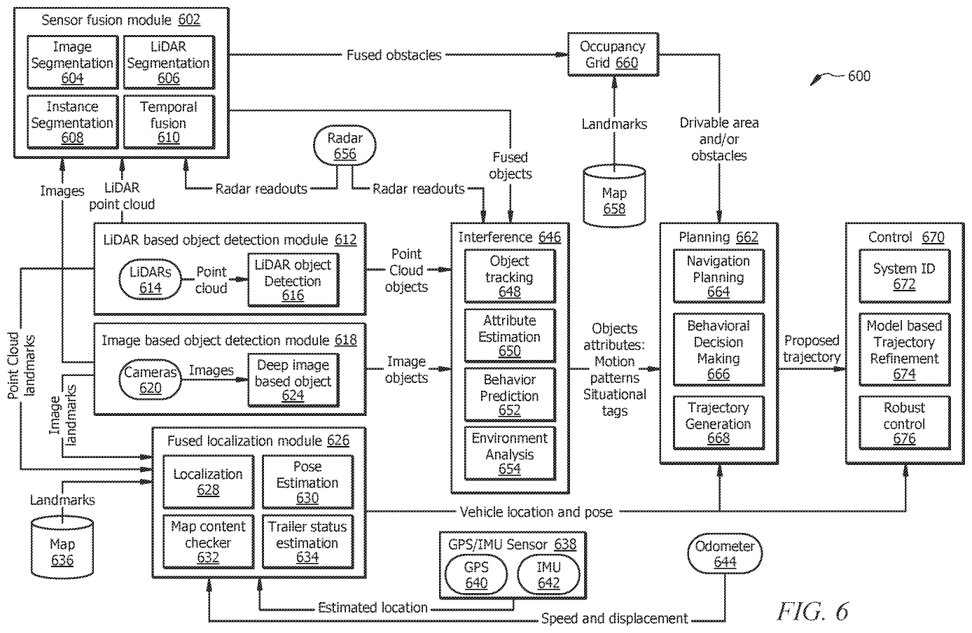

Network interface 124 may be a component of the network communication subsystem 592 described in FIG. 6. The network interface 124 may be configured to enable wired and/or wireless communications. The network interface 124 may be configured to communicate data between the autonomous vehicle 502 and other devices, systems, or domains. For example, the network interface 124 may comprise an NFC interface, a Bluetooth interface, a Zigbee interface, a Z-wave interface, a radio-frequency identification (RFID) interface, a WIFI interface, a local area network (LAN) interface, a wide area network (WAN) interface, a metropolitan area network (MAN) interface, a personal area network (PAN) interface, a wireless PAN (WPAN) interface, a modem, a switch, and/or a router. The processor 122 may be configured to send and receive data using the network interface 124. The network interface 124 may be configured to use any suitable type of communication protocol as would be appreciated by one of ordinary skill in the art.

The memory 126 may be one of the data storages 590 described in FIG. 5. The memory 126 may be volatile or non-volatile and may comprise read-only memory (ROM), random-access memory (RAM), ternary content-addressable memory (TCAM), dynamic random-access memory (DRAM), and static random-access memory (SRAM). The memory 126 may include one or more of a local database, cloud database, network-attached storage (NAS), etc. The memory 126 may store any of the information described in FIGS. 1-7 along with any other data, instructions, logic, rules, or code operable to implement the function(s) described herein when executed by processor 122. For example, the memory 126 may store software instructions 128, sensor data 130, object detection machine learning module 132, map data 134, routing plan 136, driving instructions 138, landing pad sensor signals 212, launch pad sensor signals 218, routes 230, 240, and/or any other data/instructions. The software instructions 128 include code that when executed by the processor 122 causes the control device 550 to perform the functions described herein, such as some or all of those described in FIGS. 1-7. The memory 126 comprises one or more disks, tape drives, or solid-state drives, and may be used as an over-flow data storage device, to store programs when such programs are selected for execution, and to store instructions and data that are read during program execution.

Object detection machine learning modules 132 may be implemented by the processor 122 executing software instructions 128, and may be generally configured to detect objects and obstacles from the sensor data 130. The object detection machine learning modules 132 may be implemented using neural networks and/or machine learning algorithms for detecting objects from any data type, such as images, videos, infrared images, point clouds, Radar data, etc.

In some embodiments, the object detection machine learning modules 132 may be implemented using machine learning algorithms, such as Support Vector Machine (SVM), Naive Bayes, Logistic Regression, k-Nearest Neighbors, Decision Trees, or the like. In some embodiments, the object detection machine learning modules 132 may utilize a plurality of neural network layers, convolutional neural network layers, Long-Short-Term-Memory (LSTM) layers, Bi-directional LSTM layers, recurrent neural network layers, and/or the like, in which weights and biases of these layers are optimized in the training process of the object detection machine learning modules 132. The object detection machine learning modules 132 may be trained by a training dataset that may include samples of data types labeled with one or more objects in each sample. For example, the training dataset may include sample images of objects (e.g., vehicles, lane markings, pedestrians, road signs, obstacles, etc.) labeled with object(s) in each sample image. Similarly, the training dataset may include samples of other data types, such as videos, infrared images, point clouds, Radar data, etc. labeled with object(s) in each sample data. The object detection machine learning modules 132 may be trained, tested, and refined by the training dataset and the sensor data 130. The object detection machine learning modules 132 use the sensor data 130 (which are not labeled with objects) to increase their accuracy of predictions in detecting objects. For example, supervised and/or unsupervised machine learning algorithms may be used to validate the predictions of the object detection machine learning modules 132 in detecting objects in the sensor data 130.

Map data 134 may include a virtual map of a city or an area that includes the road traveled by an autonomous vehicle 502. In some examples, the map data 134 may include the map 658 and map database 636 (see FIG. 6 for descriptions of the map 658 and map database 636). The map data 134 may include drivable areas, such as roads, paths, highways, and undrivable areas, such as terrain (determined by the occupancy grid module 660, see FIG. 6 for descriptions of the occupancy grid module 660). The map data 134 may specify location coordinates of road signs, lanes, lane markings, lane boundaries, road boundaries, traffic lights, obstacles, etc.

Routing plan 136 may be a plan for traveling from a start location (e.g., a first autonomous vehicle launchpad/landing pad) to a destination (e.g., a second autonomous vehicle launchpad/landing pad). For example, the routing plan 136 may specify a combination of one or more streets, roads, and highways in a specific order from the start location to the destination. The routing plan 136 may specify stages, including the first stage (e.g., moving out from a start location/launch pad), a plurality of intermediate stages (e.g., traveling along particular lanes of one or more particular street/road/highway), and the last stage (e.g., entering the destination/landing pad). The routing plan 136 may include other information about the route from the start position to the destination, such as road/traffic signs in that routing plan 136, etc.

Driving instructions 138 may be implemented by the planning module 662 (See descriptions of the planning module 662 in FIG. 6.). The driving instructions 138 may include instructions and rules to adapt the autonomous driving of the autonomous vehicle 502 according to the driving rules of each stage of the routing plan 136. For example, the driving instructions 138 may include instructions to stay within the speed range of a road traveled by the autonomous vehicle 502, adapt the speed of the autonomous vehicle 502 with respect to observed changes by the sensors 546, such as speeds of surrounding vehicles, objects within the detection zones of the sensors 546, etc.

### Autonomous Freight Network Terminal

Autonomous freight network terminal 140 is described in greater detail in FIG. 2. In brief, the autonomous freight network terminal 140 facilitates inbound and outbound operations for autonomous vehicles 502. For example, the autonomous freight network terminal 140 facilitates autonomous vehicles 502 entering the terminal 140, inspections of the autonomous vehicles 502, unloading a load carried by a trailer of an autonomous vehicle 502, servicing the autonomous vehicles 502, loading a trailer of an autonomous vehicle 502 with a new load, uploading updated data (e.g., updated map data 134 and/or updated software instructions 128) to the control device 550 associated with the autonomous vehicle 502, and the autonomous vehicle 502 exiting the autonomous freight network terminal 140. The autonomous freight network terminal 140 may facilitate preparing tractor-units of autonomous vehicles 502 for the transportation of cargo or freight along a route, automatically dispatching autonomous vehicles 502 from launch pads 142h (see FIG. 2), and safely receiving incoming autonomous vehicles 502 at appropriate landing pads 142a (see FIG. 2). The terminal 140 may facilitate the operation of autonomous vehicles 502 and conventional tractor units driven by human drivers.

In certain embodiments, the terminal 140 may include dedicated zones 142, boundary indicators 144, sensors 146, and a data and control command center 148. Each of the dedicated zones 142 may be configured to facilitate a particular function for any autonomous vehicle 502 in a fleet of autonomous vehicles 502. For example, the dedicated zones 142 may include landing pads, launch pads, loading and unloading zone, trailer staging zone, maintenance and data communication zones, and tractor staging zone. These dedicated zones 142 are described in greater detail in FIG. 2.

In certain embodiments, each dedicated zone 142 may be established by a set of boundary indicators 144 disposed around a respective dedicated zone 142. Examples of a boundary indicator 144 may include a position delineator, a yellow zone, a traffic cone, and the like. In certain embodiments, each dedicated zone 142 may be established by paint markings on concrete around the perimeter of the respective dedicated zone 142. In certain embodiments, a boundary indicator 144 may be integrated with one or more sensors 146. In certain embodiments, a boundary indicator 144 and a sensor 146 may be distinct devices.

Sensors 146 may include any sensor configured to detect objects within a detection range. Examples of the sensors 146 may include cameras, infrared sensors, motion sensors, heat sensors, and light detection and ranging (LiDAR) sensors. Each sensor 146 is communicatively coupled with the AFN management device 150 and optionally with other components of the system 100. Each sensor 146 may be disposed at various locations within the terminal 140. For example, some sensors 146 may be disposed around a perimeter of a dedicated zone 142 and/or within the dedicated zone 142.

Each sensor 146 is configured to detect objects within its detection range and produce sensor signals 212, 218 (see FIG. 2). The sensor 146 may communicate the sensor signals 212, 218 (see FIG. 2) to the AFN management device 150 and/or any other component of the system 100. The AFN management device 150 may use the received sensor signals 212, 218 (see FIG. 2) to determine the locations of objects detected in the sensor signals 212, 218 (see FIG. 2). The AFN management device 150 may determine landing instructions 162 for an incoming autonomous vehicle 502 based on the received information. For example, the landing instructions 162 may indicate to avoid the locations where objects are detected in a traveling path of the incoming autonomous vehicle 502. The AFN management device 150 may further determine launching instructions 166 for an outgoing autonomous vehicle 502 based on the received information. For example, the launching instructions 166 may indicate to avoid the locations where objects are detected in a traveling path of the outgoing autonomous vehicle 502. These operations are described in greater detail in FIG. 2.

The data and control command center 148 may include a physical space where the AFN management device 150 is located. The data and control command center 148 is generally a space where administrators of the terminal 140 are located to oversee operations at the terminal 140. In some embodiments, the data and control command center 148 houses the AFN management device 150 which is in communication with autonomous vehicles 502 and sensors 146 associated with the dedicated zones 142, including the launchpads and landing pads to implement various functions of the launchpads and landing pads described in this disclosure. These operations are described in greater detail in FIG. 2.

### Computing Device

Each of the computing devices 104a and 140b is an instance of a computing device 104. Computing device 104 is generally any device that is configured to process data and interact with users 102. Examples of the computing device 104 include, but are not limited to, a personal computer, a desktop computer, a workstation, a server, a laptop, a tablet computer, a mobile phone (such as a smartphone), etc. The computing device 104 may include a user interface, such as a display, a microphone, keypad, or other appropriate terminal equipment usable by users. The computing device 104 may include a hardware processor, memory, and/or circuitry (not explicitly shown) configured to perform any of the functions or actions of the computing device 104 described herein. For example, a software application designed using software code may be stored in the memory and executed by the processor to perform the functions of the computing device 104. The computing device 104 is configured to communicate with other devices via the network 110, such as the AFN management device 150.

### Autonomous Freight Network Management Device

Autonomous freight network (AFN) management device 150 may include one or more processing and computing devices, and is generally configured to optimize inbound and outbound navigations of autonomous vehicles 502 and reduce inbound and outbound delays. The AFN management device 150 may further be configured to oversee operations of autonomous vehicles 502 while they are in transit (e.g., on a road) and inside the terminal 140. Examples of the AFN management device 150 may include a server, a workstation, a cloud of servers, and the like.

The AFN management device 150 may comprise a processor 152, a network interface 154, a user interface 156, and a memory 158. The components of The AFN management device 150 are operably coupled to each other. The processor 152 may include one or more processing units that perform various functions of the AFN management device 150. The memory 158 may store any data and/or instructions used by the processor 152 to perform its functions. For example, the memory 158 may store software instructions 160 that when executed by the processor 152 causes the AFN management device 150 to perform one or more functions described herein. The AFN management device 150 may be configured as shown or in any other suitable configuration.

In one embodiment, the AFN management device 150 may be implemented by a cluster of computing devices that may serve to oversee the operations of the autonomous vehicle 502 and operations performed on each autonomous vehicle 502 in the terminal 140. For example, the AFN management device 150 may be implemented by a plurality of computing devices using distributed computing and/or cloud computing systems. In another example, the AFN management device 150 may be implemented by a plurality of computing devices in one or more data centers. As such, in one embodiment, the AFN management device 150 may include more processing power than the control device 550. The AFN management device 150 is in signal communication with the autonomous vehicle 502 and its components (e.g., the control device 550), the computing devices 104, and sensors 146.

Processor 152 comprises one or more processors. The processor 152 is any electronic circuitry, including state machines, one or more CPU chips, logic units, cores (e.g., a multi-core processor), FPGAs, ASICs, or DSPs. The processor 152 may be a programmable logic device, a microcontroller, a microprocessor, or any suitable combination of the preceding. The processor 152 may be communicatively coupled to and in signal communication with the network interface 154, user interface 156, and memory 158. The one or more processors are configured to process data and may be implemented in hardware or software. For example, the processor 152 may be 8-bit, 16-bit, 32-bit, 64-bit or of any other suitable architecture. The processor 152 may include an ALU for performing arithmetic and logic operations, processor registers that supply operands to the ALU and store the results of ALU operations, and a control unit that fetches instructions from memory and executes them by directing the coordinated operations of the ALU, registers and other components. The one or more processors are configured to implement various instructions. For example, the one or more processors are configured to execute software instructions 160 to implement the functions disclosed herein, such as some or all of those described with respect to FIGS. 1-7. In some embodiments, the function described herein may be implemented using logic units, FPGAs, ASICs, DSPs, or any other suitable hardware or electronic circuitry.

Network interface 154 may be configured to enable wired and/or wireless communications of the AFN management device 150. The network interface 154 may be configured to communicate data between the AFN management device 150 and other devices, servers, autonomous vehicles 502, systems, or domains. For example, the network interface 154 may comprise an NFC interface, a Bluetooth interface, a Zigbee interface, a Z-wave interface, an RFID interface, a WIFI interface, a LAN interface, a WAN interface, a PAN interface, a modem, a switch, and/or a router. The processor 152 may be configured to send and receive data using the network interface 154. The network interface 154 may be configured to use any suitable type of communication protocol as would be appreciated by one of ordinary skill in the art.

User interfaces 156 may include one or more user interfaces that are configured to interact with users, such as the remote operator 180. The remote operator 180 may be an administrator working at the terminal 140. The remote operator 180 may access the AFN management device 150 using the user interfaces 156. The user interfaces 156 may include peripherals of the AFN management device 150, such as monitors, keyboards, mouse, trackpads, touchpads, microphones, webcams, speakers, and the like. The remote operator 180 may use the user interfaces 156 to access the memory 158 to review any data stored in the memory 158, such as the post-trip inspection report 164 and pre-trip inspection report 168. The remote operator 180 may confirm, update, and/or override the landing instructions 162, launching instructions 166, and/or any other data stored in memory 158.

Memory 158 may be volatile or non-volatile and may comprise ROM, RAM, TCAM, DRAM, and SRAM. The memory 158 may include one or more of a local database, cloud database, NAS, etc. Memory 158 may store any of the information described in FIGS. 1-7 along with any other data, instructions, logic, rules, or code operable to implement the function(s) described herein when executed by processor 152. For example, the memory 158 may store software instructions 160, sensor data 130, object detection machine learning module 132, map data 134, routing plan 136, driving instructions 138, landing instructions 162, post-trip inspection report 164, launching instructions 166, pre-trip inspection report 168, trips 170, landing pad sensor signals 212, launch pad sensor signals 218, and/or any other data/instructions. The software instructions 160 may include code that when executed by the processor 152 causes the AFN management device 150 to perform the functions described herein, such as some or all of those described in FIGS. 1-7. The memory 158 comprises one or more disks, tape drives, or solid-state drives, and may be used as an over-flow data storage device, to store programs when such programs are selected for execution, and to store instructions and data that are read during program execution.

### Example Autonomous Freight Network Terminal

FIG. 2 illustrates an example embodiment of an autonomous freight network terminal 140. In the illustrated embodiment, the terminal 140 includes dedicated zones 142, boundary indicators 144, sensors 146, and data and control command center 148.

The dedicated zones 142 may include the landing pads 142a, trailer drop off and staging zone 142b, loading and unloading zone 142c, maintenance and data communication zone 142d (that includes data communication zone 142e and maintenance/service zone 1420, tractor staging zone 142g, and launch pads 142h.

Landing pads 142a are generally predefined zones or regions that facilitate incoming autonomous vehicles 502 to safely arrive at and park in the predefined zones. The landing pads 142a may include a set of landing pad lanes 210. Each landing pad lane 210 may be associated with a landing pad 142a. Each landing pad 142a may be associated with an identifier (ID) number. In certain embodiments, the boundary of the landing pads 142a is determined by boundary indicators 144 disposed around the edges of each landing pad lane 210. The landing pads 142a may be established by paint markings around the perimeter of each landing pad 142a. The landing pads 142a may be with associated sensors 146 which are used to determine whether the zone is free of obstructions that would prevent an autonomous vehicle 502 from safely arriving at and parking in the zone. For example, a landing pad 142a may be a physical pad (e.g., constructed of concrete or any appropriate material) that includes, is embedded with and/or is surrounded by sensors 146. Examples of the sensors 146 are described in FIG. 1. In certain embodiments, a post-trip inspection 222 may be performed on the autonomous vehicle 502 while the autonomous vehicle 502 is in a landing pad 142a. This process is described in greater detail further below.

In the illustrated embodiment, each landing pad 142a is observed by four sensors 146. In other embodiments, any suitable number of sensors 146 may be deployed to observe each landing pad 142a. In the illustrated embodiment, the landing pads 142a are shown to have three landing pads 142a. In other embodiments, the landing pads 142a may include any number of landing pads 142a.

While the example of FIG. 2 shows sensors 146 near the landing pads 142a and launch pads 13h, it is understood that any number of sensors 146 may be disposed at any suitable location within the terminal 140, e.g., along traveling paths between the entrance of the terminal 140 to the landing pads 142a and launch pads 142h.

While the example terminal 140 of FIG. 2 shows separate landing pads 142a and launch pads 142h, in other embodiments, the same structure (i.e., a predefined zone that includes appropriate sensors for detecting whether the zone is free of obstructions) may be used as both a landing pad 142a and a launchpad 142h. In certain embodiments, the landing pad 142a may be bi-directional, meaning that an autonomous vehicle 502 is able to arrive at and park in the landing pad 142a from both directions. In certain embodiments, the landing pad 142a may be unidirectional, meaning that an autonomous vehicle 502 is able to arrive at and park in the landing pad 142a from one direction.

The sensors 146 are configured to detect objects on and around the landing pads 142a and the launch pads 142h. The sensors 146 associated with (e.g., observing) the landing pads 142a may produce landing pad sensor signals 212 that indicate locations of objects detected in and in the vicinity of the landing pads 142a. The sensors 146 may communicate the landing pad sensor signals 212 to the AFN management device 150.

In certain embodiments, the AFN management device 150 may use the landing pad sensor signals 212 to determine whether there is any obstruction or object in the traveling path of the incoming autonomous vehicle 502 to the landing pad 142a.

If the AFN management device 150 determines that there is an object in the traveling path of the incoming autonomous vehicle 502 to the landing pad 142a, the AFN management device 150 may determine landing instructions 162 that indicate to avoid the locations of the detected objects from the sensor signals 212. The AFN management device 150 may communicate the landing instructions 162 to the incoming autonomous vehicle 502.

The control device 550 of the incoming autonomous vehicle 502 may use the landing instructions 162 and sensor data 130 captured by its sensors 546 to instruct the autonomous vehicle 502 to take a route 230 that is free of obstructions and objects detected in either of sensor signals 212 and the sensor data 130 to reach the landing pad 142a. An example operational flow 200 for determining and communicating the landing instructions 162 to an incoming autonomous vehicle 502 is described further below.

In certain embodiments, the AFN management device 150 may use the landing pad sensor signals 212 to identify a landing pad 122a (e.g., a landing pad lane 210) that is free of obstructions and available to receive an incoming autonomous vehicle 502. The identified landing pad 142a may be communicated to the incoming autonomous vehicle 502 such that the autonomous vehicle 502 can safely and efficiently navigate to this landing pad 142a (or which is already known to be free of obstructions). This leads to significantly reducing the complexity of inbound autonomous vehicle 502 navigation that would otherwise be determined only based on information detected by sensors 546. If the inbound autonomous vehicle 502 detects an obstruction in the inbound lane 204 that leads to the identified landing pad 142a, the autonomous vehicle 502 may communicate this obstruction to the AFN management device 150 as the sensor data 130, and the AFN management device 150 may identify a new landing pad 142a that can be reached using a different inbound lane 203 and is free of obstructions or a different inbound lane 204 leading to the assigned landing pad 142a.

In certain embodiments, the landing pad sensor signals 212 and sensor data 130 from an autonomous vehicle 502 requesting to enter a landing pad 142a are provided to the AFN management device 150. The AFN management device 150 may use the landing pad sensor signals 212 and the sensor data 130 from the autonomous vehicle 502 to determine whether the landing pad 142a is free of obstructions. If the landing pad 142a is determined to be free of obstructions, then the AFN management device 150 allows the autonomous vehicle 502 to begin moving into the landing pad 142a. In some cases, the AFN management device 150 may further determine an inbound lane 204 (e.g., with a particular ID) for the autonomous vehicle 502 to take to enter the terminal 140 and reach a prescribed landing pad 142a identified by an ID.

Trailer staging zone 142b generally include areas within the terminal 140 that are used to store trailers when not in use or attached to an autonomous vehicle 502 that is a tractor unit. For example, the first trailer staging zone 142b may store trailers from incoming autonomous vehicles 502 arriving at the terminal 140, and the second trailer staging zone 142b may store outgoing trailers to be attached to tractor-unit autonomous vehicles 502 that will be launched from the launch pads 142h.

Loading and unloading zone 142c generally include areas within the terminal 140 that are used to load outbound trailers of autonomous vehicles 502 with a commodity to carry and transport, and unload a commodity from recently arrived autonomous vehicles 502.

Data communication zone 142e generally includes areas within the terminal 140 that are used to upload data to autonomous vehicles 502 and download data from autonomous vehicles 502. Computing devices, connection cables, Ethernet cables, switches, and/or routers (not explicitly shown) may be placed in the data communication zone 142e to facilitate data communication with autonomous vehicles 502. The data communication zone 142e may be equipped with devices to facilitate wired and/or wireless communication with the autonomous vehicles 502. For example, in preparing an autonomous vehicle 502 for a trip, if it is determined that map data 134 (see FIG. 1) and/or software instructions 128 (see FIG. 1) of the autonomous vehicle 502 need to be updated, the autonomous vehicle 502 is driven into the data communication zone 142e and the updated map data 134 (see FIG. 1) and/or software instructions 128 (see FIG. 1) may be uploaded to the autonomous vehicle 502, more specifically to the control device 550. In another example, when an autonomous vehicle 502 arrives at the terminal 140, it may be driven to the data communication zone 142e to download sensor data 130 captured during its trip by the sensors 546.

Maintenance and service zone 142f generally includes areas within the terminal 140 that used to provide services to the autonomous vehicles 502. The services may include sensor calibration, sensor housing cleaning, fuel refilling, oil refilling, tire air refilling, cooling fluid refilling, and any other services that an autonomous vehicle 502 may need to be operational. In this disclosure, the maintenance and service zone 142f may be interchangeably referred to as a service zone 132f. The service zone 142f may include resources to provide services to the autonomous vehicles 502. For example, the service zone 142f may include resources such as fuel pumps for refueling the autonomous vehicles 502 and any other vehicle operating out of the terminal 140.

Tractor staging zone 142g generally includes an area of the terminal 140 that is used to prepare tractor-unit autonomous vehicles 502 prior to departure of the autonomous vehicles 502 to begin travel along the road 202. The tractors of autonomous vehicles 502 are queued in lanes of the tractor staging zone 142g in the order as they are ready to begin traveling on the road 202.

Launchpads 142h are generally predefined zones or regions that facilitate safe and efficient automatic departure of autonomous vehicles 502 from the terminal 140. For example, a launchpad 142h may be a physical pad (e.g., constructed of concrete or any appropriate material) that includes, is embedded with and/or is surrounded by sensors 146. The launchpads 142h may include a set of launch pad lanes 216. Each launch pad lane 216 may be associated with a launch pad 142h. Each launch pad 142h may be associated with an ID number.

In certain embodiments, the boundary of the launch pads 142h are determined by boundary indicators 144 disposed around the edges of each launch pad 142h (e.g., each launch pad lane 216). The launch pads 142h may be established by paint markings around the perimeter of each launch pad 142h. The launch pads 142h may be associated with sensors 146 which are used to determine whether the zone is free of obstructions that would prevent an autonomous vehicle 502 from safely arriving at and parking in the zone. Examples of the sensors 146 are described in FIG. 1. Maintenance and pre-trip diagnostics/testing (i.e., pre-trip inspection 234) may be performed on the autonomous vehicles 502 in a launch pad 142h. This process is described in greater detail further below.

In the illustrated embodiment, each launch pad 142h is associated with (e.g., observed by) four sensors 146. In other embodiments, any suitable number of sensors 146 may be included to observe each launch pad 142h. In the illustrated embodiment, the launch pads 142h are shown to have three launch pads 142h. In other embodiments, the landing pads 142a may include any number of launch pads 142h.

In certain embodiments, the launch pad 142h may be bi-directional, meaning that an autonomous vehicle 502 is able to arrive at and park in the launch pad 142h from both directions. In certain embodiments, the launch pad 142h may be unidirectional, meaning that an autonomous vehicle 502 is able to arrive at and park in the launch pad 142h from one direction.

The sensors 146 associated with the launch pads 142h may produce launch pad sensor signals 218 that indicate locations of objects detected in and in the vicinity if the launch pads 142h. The sensors 146 may communicate the launch pad sensor signals 218 to the AFN management device 150.

In certain embodiments, the AFN management device 150 may use the launch pad sensor signals 218 from the sensors 146 of the launch pads 142h to determine whether there is any obstruction or object in a traveling path of an outgoing autonomous vehicle 502 from a launch pad 142h to exit from the terminal 140.

If the AFN management device 150 determines that there is an object in the traveling path of the outgoing autonomous vehicle 502 from the launch pad 142h to exit from the terminal 140, the AFN management device 150 may determine launching instructions 166 that indicate to avoid locations of the detected objects from the launch pad sensor signals 218. The AFN management device 150 may communicate the launching instructions 166 to the outgoing autonomous vehicle 502. The control device 550 of the outgoing autonomous vehicle 502 may use the launching instructions 166 and sensor data 130 captured by its sensors 546 to instruct the autonomous vehicle 502 to take a route 240 that is free of obstructions and objects detected in either of launch pad sensor signals 218 and the sensor data 130 to exit the terminal 140. An example operational flow 200 for determining and communicating the launching instructions 166 to an outgoing autonomous vehicle 502 is described further below.

In certain embodiments, the launch pad sensor signals and sensor data 130 from an autonomous vehicle 502 requesting to exit a launchpad 142h are provided to the AFN management device 150. The AFN management device 150 may use the launch pad sensor signals 218 and the sensor data 130 to determine whether a zone or area around the autonomous vehicle 502 is free of obstructions. If the zone around the autonomous vehicle 502 is determined to be free of obstructions, then the AFN management device 150 allows the autonomous vehicle 502 to begin moving out of the launchpad 142h. In some cases, the AFN management device 150 may further determine an outbound lane 206 (e.g., a particular outbound lane 206 with a particular ID) for the autonomous vehicle 502 to take to exit the terminal 140 and reach a road 202 used to reach a route to a prescribed destination. In certain embodiments, the control device 550 may use the sensor data 130 and the launch pad sensor signals 218 to determine a route 240 to exit the terminal 140.

Data and control command center 220 is generally a space where administrators of the terminal 140 are located to oversee operations at the terminal 140. In the illustrated embodiment, the data and control command center 220 houses the AFN management device 150 that is in communication with autonomous vehicles 502 and sensors 146 of the launchpads 142h and landing pads 142a to implement various functions of the launchpads 142h and landing pads 142a described in this disclosure. While the example of FIG. 2 shows the AFN management device 150 is located within the data and control command center 220, it should be understood that the AFN management device 150 may be located at any appropriate location and/or may be a distributed computing system. The terminal 140 may further include one or more vehicle bays, and one or more path-through bays for autonomous vehicles 502 and non-autonomous vehicles.

### Example Operational Flow for an Inbound Autonomous Vehicle

FIG. 2 further illustrates an example operational flow 200 of system 100 of FIG. 1 for inbound and outbound operations for autonomous vehicles 502 with respect to a terminal 140. In current technology, inbound and outbound operations for autonomous vehicles 502 introduce delays which reduces efficiency in autonomous vehicle 502 navigation entering and exiting the terminal 140, efficiency in preparing the autonomous vehicles 502 for next trips 170, efficiency in providing service to autonomous vehicles 502, and transmitting and receiving data to and from autonomous vehicles 502.

The system 100 of FIG. 1 is configured to implement the operational flow 200 to reduce inbound and outbound delays, and improve efficiency in autonomous vehicle 502 navigation entering and exiting the terminal 140, efficiency in preparing the autonomous vehicles 502 for next trips, efficiency in providing service to autonomous vehicles 502, and transmitting and receiving data to and from autonomous vehicles 502.

### Inbound Operation for an Incoming Autonomous Vehicle

In an example scenario, assume that an autonomous vehicle 502 is inbound to the terminal 140. For example, the autonomous vehicle 502 may be on the road 202 and traveling toward the terminal 140. The operational flow 200 may begin when the AFN management device 150 determines that the autonomous vehicle 502 is inbound to the terminal 140. For example, the AFN management device 150 may receive information that indicates the autonomous vehicle 502 is inbound to the terminal 140.

For example, the control device 550 may transmit sensor data 130 that includes location coordinates (e.g., global positioning system (GPS) location coordinates) and trajectory of the autonomous vehicle 502 to the AFN management device 150. Based on the sensor data 130, the AFN management device 150 may determine that the autonomous vehicle 502 is inbound to the terminal 140.

### Determining a Traveling Path to a Landing Pad

The AFN management device 150 may receive landing pad sensor signals 212 from the sensors 146 associated with the landing pads 142a. The landing pad sensor signals 212 may indicate whether there are objects or obstructions along the traveling path of the incoming autonomous vehicle 502 to the landing pad 142a. For example, the landing pad sensor signals 212 may indicate locations of users 102a-b, other autonomous vehicles 502, other vehicles, vehicle equipment, animals, and other objects. Based on the landing pad sensor signals 212, the AFN management device 150 may determine locations of objects that are in the traveling path of the incoming autonomous vehicle 502 to the landing pad 142a. In this process, the AFN management device 150 may feed the sensor signals 212 to the object detection machine learning module 132 (see FIG. 1) to detect the objects and their locations from the sensor signals 212. In response, the AFN management device 150 may determine landing instructions 162 for the incoming autonomous vehicle 502. The landing instructions 162 may include the locations of objects detected from the landing pad sensor signals 212. The landing instructions 162 may indicate to avoid the locations of detected objects. For example, the landing instructions 162 may include routing instructions to avoid the locations of the detected objects.

In certain embodiments, the landing instructions 162 may further include an identifier of the landing pad 142a-1, an identifier of an inbound lane 204 that the incoming autonomous vehicle 502 should take, a pathway to the landing pad 142a-1 from the prescribed inbound lane 204 to the prescribed landing pad 142a-1, and a time window during which the incoming autonomous vehicle 502 is allowed to move into the prescribed landing pad 142a-1. The time window may indicate a duration in which the landing pad 142a-1 is available to receive the incoming autonomous vehicle 502 to arrive at and park.

The AFN management device 150 may communicate the landing instructions 162 to the incoming autonomous vehicle 502. The control device 550 associated with the incoming autonomous vehicle 502 may receive the landing instructions 162. The control device 550 may determine a route 230 to take in order to reach the landing pad 142a such that the determined route 230 is free of objects. The control device 550 may instruct the autonomous vehicle 502 to travel according to the route 230 to reach the prescribed landing pad 142a (e.g., landing pad 142a-1).

In certain embodiments, the control device 550 may receive sensor data 130 that indicates objects detected by the sensors 546 associated with the incoming autonomous vehicle 502. The sensor data 130 may indicate objects detected along the traveling path of the incoming autonomous vehicle 502 to the landing pads 142a. The control device 550 may use the sensor data 130 in addition to the landing pad sensor signals 212 to determine the route 230 to an available and unoccupied landing pad 142a. Thus, determining the route 230 may be based on landing pad sensor signals 212 and sensor data 130. The control device 550 may instruct the autonomous vehicle 605 to travel according to the determined route 230 to arrive at and park in the identified landing pad 142a.

Upon arriving at the prescribed landing pad 142a-1, the control device 550 may instruct the incoming autonomous vehicle 502 to park and stop inside the landing pad 142a-1. In this process, the control device 550 may determine whether the boundary indicators 144 are detected in the sensor data 130. If the control device 550 detects the boundary indicators 144 from the sensor data 130, the control device 550 instructs the incoming autonomous vehicle 502 to travel into the landing pad 142a-1 until a particular distance (e.g., two feet, three feet, etc.) from the set of boundary indicators 144.

In certain embodiments, prior to determining the landing instructions 162, the AFN management device 150 may determine whether the landing pad 142a-1 is occupied by a second autonomous vehicle 502 or any object that prevents the incoming autonomous vehicle 502 from landing inside the landing pad 142a-1. If it is determined that the landing pad 142a-1 is not occupied by another autonomous vehicle 502 or any object that prevents the incoming autonomous vehicle 502 from landing inside the landing pad 142a-1, the AFN management device 150 may determine the landing instructions 162. For example, assume that the AFN management device 150 detects that the landing pad 142a-2 is occupied by a second autonomous vehicle 502 based on analyzing the landing pad sensor signals 212. In this example, the AFN management device 150 may indicate in the landing instructions 162 that the landing pad 142a-2 is occupied. In response, the control device 550 may exclude the landing pad 142a-2 from consideration to land in. In another example, assume that the AFN management device 150 detects an object 208 and its location by analyzing the landing pad sensor signals 212. The AFN management device 150 may include the location of the object 208 in the landing instructions 162. Since the object 208 is in the traveling path toward the landing pad 142a-3, the control device 550 may exclude the landing pad 142a-3 from consideration to land in.

In certain embodiments, in response to receiving the landing pad sensor signals 212, the AFN management device 150 may determine a particular landing pad 142a for the incoming autonomous vehicle 502 to land in. For example, the AFN management device 150 may determine that the landing pad 142a-2 is occupied by another autonomous vehicle 502, the traveling path to the landing pad 142a-3 is obstructed by the object 208, and the landing pad 142a-1 is not occupied by any object and is ready to receive the incoming autonomous vehicle 502. In response, the AFN management device 150 may determine landing instructions 162 that indicate to land in the landing pad 142a-1. In this example, the landing instructions 162 may include an identifier of the landing pad 142a-1, an identifier of an inbound lane 204, a pathway to the landing pad 142a-1 from the prescribed inbound lane 204 to the prescribed landing pad 142a-1, and a time window during which the incoming autonomous vehicle 502 is allowed to move into the prescribed landing pad 142a-1. The time window may indicate a duration in which the landing pad 142a-1 is available to receive the incoming autonomous vehicle 502 to arrive at and park.

If the AFN management device 150 determines a landing pad 142a is occupied by a second autonomous vehicle 502 or any object that prevents the incoming autonomous vehicle 502 from landing inside the landing pad 142a, the AFN management device 150 may identify another landing pad 142a, e.g., that is free of obstruction, and a traveling path to it is free of obstruction, i.e., is available to receive the incoming autonomous vehicle 502. The AFN management device 150 may determine updated landing instructions 162 that comprise a route to the available landing pad 142a.

The AFN management device 150 may communicate the updated landing instructions 162 to the incoming autonomous vehicle 502. The control device 550 associated with the incoming autonomous vehicle 502 may instruct the autonomous vehicle 502 to travel according to the updated landing instructions 162.

### Post-Trip Inspection

When the incoming autonomous vehicle 502 is arrived and parked at the prescribed landing pad 142a-1, the post-trip inspection 222 may be performed on the autonomous vehicle 502. The post-trip inspection 222 may be performed by a user 102a who is a certified technician or an inspector. During the post-trip inspection 222, functions and health levels of various components of the autonomous vehicle 502 are checked and tested, such as the functions and health levels of vehicle subsystems 540 described in FIG. 5. The user 102a may indicate the functions and health levels of the components of the autonomous vehicle 502 in the computing device 104a, and generate a post-trip inspection report 232. The user 102a may communicate the post-trip inspection report 232 to the AFN management device 150 from the computing device 104a. In this way, the AFN management device 150 determines that the post-trip inspection 222 is performed on the autonomous vehicle 502.

### Trailer Drop Off

As described in the description of autonomous vehicle 502 in FIG. 1 and shown in FIGS. 2 and 5, the autonomous vehicle 502 may be a tractor unit attached to a trailer that carries the load. A technician (e.g., user 102a) may disconnect the tractor from the trailer while the autonomous vehicle 502 is on the landing pad 142a-1.

Assume that the incoming autonomous vehicle 502 has transported a load to the terminal 140. The tractor of the autonomous vehicle 502 may be moved to the loading and unloading zone 142c so that the load can be unloaded from the trailer, e.g., by staff working at the terminal 140, by another automated system.

The AFN management device 150 may determine a trailer drop off zone 142b to drop off the trailer of the autonomous vehicle 502. The trailer drop off zone 142b may have occupied lots and available lots. In certain embodiments, the AFN management device 150 may determine a particular lot in the trailer drop off zone 142b to drop off the trailer of the autonomous vehicle 502. The AFN management device 150 may communicate the determined drop off zone 142b that is available for receiving the trailer (e.g., the available lot in the drop off zone 142b) to a computing device (e.g., computing device 104a or 120b) associated with a driver (e.g., user 102a or 102b) of a vehicle that is configured to move the trailer. The driver may transport the trailer of the autonomous vehicle 502 to the determined drop off zone 142b that is available to receive the trailer. The driver may confirm on the computing device that the trailer is moved to the prescribed drop off zone 142b. The driver, from the computing device, may communicate a message to the AFN management device 150 that indicates that the trailer is moved to the prescribed drop off zone 142b. The AFN management device 150 may receive the confirmation message from the computing device. The driver may refer to a control system of an automated or autonomous system configured to move trailers to appropriate locations. Such automated or autonomous systems may include an automated yard dog (e.g., an autonomous vehicle) or any other apparatus or system configured to connect to/disconnect to a trailer and transport it to an appropriate location within a terminal yard or port side yard.

### Uploading Data to the Autonomous Vehicle

In certain embodiments, after the post-trip inspection 222 is performed on the autonomous vehicle 502, the post-trip inspection report 232 may indicate that the map data 134 (see FIG. 1) and/or software instructions 128 (see FIG. 1) are not up to date. The map data 134 (see FIG. 1) may include routes and location coordinates of objects on the routes and road 202 within a traveling range of the autonomous vehicle 502. The software instructions 128 (see FIG. 1) may include autonomy software code that facilitates autonomous functions of the autonomous vehicle 502. For example, the map data 134 (see FIG. 1) and/or software instructions 128 (see FIG. 1) may have gone through updates while the autonomous vehicle 502 was in transit. In this manner, the AFN management device 150 may determine that at least one of the map data 134 (see FIG. 1) and the software instructions 128 (see FIG. 1) needs to be updated. In response, the AFN management device 150 may determine a data communication zone 142e. For example, the AFN management device 150 may determine a lot inside the data communication zone 142e that is available to receive the autonomous vehicle 502. The data communication zone 142e is configured to facilitate communicating data, such as map data 134 (see FIG. 1) and software instructions 128 (see FIG. 1) to the autonomous vehicle 502 and receive data, such as sensor data 130 from the autonomous vehicle 502.

The AFN management device 150 may communicate the data communication zone 142e to a computing device (e.g., computing device 104a or 120b) associated with a driver (e.g., user 102a or 102b). The driver may manually drive the tractor of the autonomous vehicle 502 to the data communication zone 142e. The driver, from the computing device, may communicate a message to the AFN management device 150 that indicates the tractor of the autonomous vehicle 502 is moved to the data communication zone 142e. The AFN management device 150 may receive, from the computing device, the confirmation message indicating that the tractor of the autonomous vehicle 502 is moved to the data communication zone 142e.

The updated map data 134 (see FIG. 1) and/or updated software instructions 128 (see FIG. 1) may be uploaded to the control device 550 of the tractor of the autonomous vehicle 502, e.g., using wired and/or wireless communications. For example, the AFN management device 150 may communicate the updated map data 134 (see FIG. 1) and/or updated software instructions 128 (see FIG. 1) to the control device 550. In another or the same example, computing devices, servers, routers, Ethernet cables, and/or communication devices resident in the data communication zone 142e and communicatively coupled to the AFN management device 150 may be used to communicate the updated map data 134 (see FIG. 1) and/or updated software instructions 128 (see FIG. 1) to the control device 550.

In certain embodiments, while the autonomous vehicle 502 was in transit, the sensors 546 may have captured sensor data 130 that may include the latest changes on the road 202 (e.g., a construction zone, a road closure, etc.), performance report of the components of the autonomous vehicle 502 (e.g., the performance of sensors 546 and vehicle subsystems 540 (see FIG. 6), and any other information.

The captured information by the sensors 546 while the autonomous vehicle 502 was in transit may be large in size (e.g., more than one gigabits (Gb), two Gb, etc.), and may require a large network communication bandwidth to transfer. The captured information may be downloaded from the control device 550 at the data communication zone 142e, for example by the AFN management device 150 via computing devices resident at the data communication zone 142e and communicatively coupled with the AFN management device 150. The AFN management device 150 may use the captured information to update the map data 134 (see FIG. 1), software instructions 129 (see FIG. 1), object detection machine learning module 132 (see FIG. 1), and any other data used to operate and navigate the autonomous vehicles 502.

### Providing a Service to the Autonomous Vehicle

In certain embodiments, after the post-trip inspection 222 is performed on the autonomous vehicle 502, the post-trip inspection report 232 may indicate that the autonomous vehicle 502 needs a service. The service may include sensor calibration, sensor housing cleaning, fuel refilling, oil refilling, tire air refilling, cooling fluid refilling, battery charging, battery exchange, and any other service that makes the autonomous vehicle 502 operational. In this manner, the AFN management device 150 may determine that the autonomous vehicle 502 needs a service based on the post-trip inspection report 232. In response, the AFN management device 150 may determine a service zone 142f. For example, the AFN management device 150 may determine a spot inside the service zone 142f that is available to receive the autonomous vehicle 502.

The AFN management device 150 may communicate the service zone 142f to a computing device (e.g., computing device 104a or 120b) associated with a driver (e.g., user 102a or 102b) or an autonomous yard dog or other mechanism to move a trailer configured to attach to and separate from a trailer. The driver drives the tractor of the autonomous vehicle 502 to the service zone 142f. The driver, from the computing device, may communicate a message to the AFN management device 150 that indicates the tractor of the autonomous vehicle 502 is moved to the service zone 142f. The AFN management device 150 may receive, from the computing device, the confirmation message indicating that the tractor of the autonomous vehicle 502 is moved to the service zone 142f. The service (e.g., indicated in the post-trip inspection report 232) may be provided to the tractor of the autonomous vehicle 502 at the service zone 142f, e.g., by a technician. Upon completion of the service, the tractor of the autonomous vehicle 502 may be moved to the tractor staging zone 142g.

In certain embodiments, after the post-trip inspection 222 is performed on the autonomous vehicle 502 (and optionally after providing a required service to the autonomous vehicle 502 and/or updating data for operating the autonomous vehicle 502 as described above), the AFN management device 150 may determine that the tractor of the autonomous vehicle 502 is ready for a next trip 170. For example, if the AFN management device 150 determines that the tractor of the autonomous vehicle 502 is roadworthy and the control device 550 is operational and updated, the AFN management device 150 may determine that the tractor of the autonomous vehicle 502 is ready for the next trip 170. In response, the AFN management device 150 may determine a tractor staging zone 142g. For example, the AFN management device 150 may determine a lot inside the tractor staging zone 142g that is available to receive the tractor. The tractor staging zone 142g may be an area where the tractor is positioned to indicate that the tractor is ready for the next trip.

The AFN management device 150 may communicate the tractor staging zone 142g to a computing device (e.g., computing device 104a or 120b) associated with a driver (e.g., user 102a or 102b). The driver may drive the tractor to the tractor staging zone 142g. The driver may communicate a message to the AFN management device 150 that indicates the tractor of the autonomous vehicle 502 is moved to the tractor staging zone 142g from the computing device. The AFN management device 150 may receive, from the computing device, a confirmation message that indicates the tractor is moved to the tractor staging zone 142g. Now, the tractor is placed in a queue of tractors that are ready for next trip 170. when the next trip 170 or mission is received, the AFN management device 150 may assign the next trip 170 to the first tractor in the queue of tractors.

### Outbound Operation

In an example scenario, assume that the autonomous vehicle 502 is outbound from the autonomous vehicle 502. The AFN management device 150 may determine that the autonomous vehicle 502 is outbound from the autonomous vehicle 502 in response to receiving a trip 170 or a mission. For example, the AFN management device 150 may receive information indicating that the autonomous vehicle 502 is outbound from the terminal 140, e.g., from a remote operator 180 (see FIG. 1). In response, the AFN management device 150 may access a trip 170 that is scheduled for the autonomous vehicle 502. The trip 1710 may indicate a start location (e.g., terminal 140), a load (to be transported by the autonomous vehicle 502), a departure time window, an arrival time window, and a destination (e.g., another terminal 140). In response, the autonomous vehicle 502 may be prepared for the trip 170. In this process, a trailer may be moved to loading and unloading zone 142c to be loaded with the load indicated in the trip 170. The remote operator 180 (see FIG. 1) may indicate the ID of the trailer to be used for this trip 170. One or more technicians (e.g., user 102a and/or 102b) may load the trailer with the load. The remote operator 180 (see FIG. 1) may communicate the ID of the trailer to the AFN management device 150.

The AFN management device 150 may identify the trailer that carries the load for the trip 170 based on the provided trailer ID. In certain embodiments, the AFN management device 150 may identify a particular launch pad 142h that is available to receive the trailer (e.g., any of the launch pads 142h-1, 142h-2, and 142h-3).

In the illustrated example, the AFN management device 150 may determine that the launch pad 142h-1 is available to receive the trailer. The AFN management device 150 may communicate the identified launch pad 142h-1 to the computing device (e.g., computing device 104a or 120b) associated with a driver (e.g., user 102a or 102b). The driver (e.g., user 102a or 102b) may move the loaded trailer to the launch pad 142h-1. The AFN management device 150 may determine that the trailer is moved to the prescribed launch pad 142h-1, e.g., in response to receiving a message from the computing device associated with the driver.

Similarly, the AFN management device 150 may determine that the tractor is moved to the prescribed launch pad 142h-1, e.g., in response to receiving a message from the computing device associated with the driver. Now that both the tractor and the trailer are in the launch pad 142h-1, the user 102b may attach the tractor to the trailer. This process may lead to assembling the autonomous vehicle 502. The user 102b may communicate a message that indicates the tractor is attached to the trailer to the AFN management device 150 from the computing device 104b. The AFN management device 150 may determine that the tractor is attached to the trailer at the launch pad 142h-1, e.g., in response to receiving the message from the computing device 104b.

### Pre-Trip Inspection

The user 102b may perform a pre-trip inspection 234 on the autonomous vehicle 502. During the pre-trip inspection 234, the functions and health levels of components of the autonomous vehicle 502, such as the vehicle subsystems 540 (see FIG. 6) are checked and tested.

In certain embodiments, the pre-trip inspection 234 may include determining the health levels of the components of the autonomous vehicle 502, including the vehicle subsystems 540 (see FIG. 5). If the health levels of the components of the autonomous vehicle 502 are more than a threshold percentage (e.g., more than 90%, 95%, etc.), it is determined that the autonomous vehicle 502 has passed the pre-trip inspection 234. In this case, the autonomous vehicle 502 is cleared for the trip 170. Otherwise, it is determined that the autonomous vehicle 502 has failed the pre-trip inspection 234. In this case, the autonomous vehicle 502 does not receive permission to launch. The user 102b may generate a pre-trip inspection report 236 and send it to the AFN management device 150 from the computing device 104b. In this manner, the AFN management device 150 may determine that the pre-trip inspection 234 is complete. The AFN management device 150 may determine that the autonomous vehicle 502 is cleared to launch based on the pre-trip inspection report 236.

### Determining a Traveling Path to Exit the Terminal

The AFN management device 150 may receive launch pad sensor signal 218 from the sensors 146 associated with the launch pads 142h. The launch pad sensor signals 218 may indicate locations of objects inside and in the vicinity of the launch pads 142h, e.g., in a traveling path of the autonomous vehicle 502 from the launch pad 142h-1 to exit the terminal 140.

The AFN management device 150 may determine launching instructions 166 based on the launch pad sensor signals 218. The launching instructions 166 may include locations of objects that are in the traveling path of the autonomous vehicle 502 from the launch pad 142h-1 to exit the terminal 140. In certain embodiments, the launching instructions 166 may further include a time window during which the autonomous vehicle 502 is allowed to exit the launch pad 142h-1, and an ID of an outbound lane 206 that the autonomous vehicle 502 should take to exit the terminal 140. The launching instructions 166 may indicate to avoid the locations of objects detected in the exit traveling path of the autonomous vehicle 502. For example, the launching instructions 166 may include routing instructions to avoid such locations of objects.

The AFN management device 150 may communicate the launching instructions 166 to the autonomous vehicle 502 which is at the launch pad 142h-1. The control device 550 of the autonomous vehicle 502 may receive the launching instructions 166. The control device 550 may determine a route 240 for the autonomous vehicle 502 to take in order to exit the terminal 140 and start the trip 170. The route 240 is free of objects detected from the launch pad sensor signals 218. The control device 550 may instruct the autonomous vehicle 502 to travel according to the route 240.

In certain embodiments, the control device 550 may receive sensor data 130 from the sensors 546, where the sensor data 130 may indicate objects and their locations along a traveling path of the autonomous vehicle 502. The control device 550 may use the sensor data 130 as well as the launching instructions 166 to determine the route 240.

In certain embodiments, determining the launching instructions 166 may be in response to determining that launch pad 142h-1 is not occupied by a second autonomous vehicle 502 or any object that prevents the outbound autonomous vehicle 502 from landing inside the launch pad 142h-1.

If the AFN management device 150 determines that a launch pad 142h is occupied by a second autonomous vehicle 502 or any object that prevents the outbound autonomous vehicle 502 from landing inside the launch pad 142h, the AFN management device 150 may identify another launch pad 142h (e.g., launch pad 142h-1) that is not occupied by another autonomous vehicle 502 or any object that prevents the outbound autonomous vehicle 502 from landing inside the launch pad 142h.

The AFN management device 150 may determine updated launching instructions 166 that comprises a second route from the available launch pad 142h to the exit the terminal 140. The AFN management device 150 may communicate the updated launching instructions 166 to the outbound autonomous vehicle 502. The control device 550 may instruct the outbound autonomous vehicle 502 to travel according to the updated launching instructions 166.

### Example Method of Inbound Operation

FIG. 3 illustrates an example flowchart of a method 300 for implementing an inbound operation for an incoming autonomous vehicle 502 to a terminal 140. Modifications, additions, or omissions may be made to method 300. Method 300 may include more, fewer, or other operations. For example, operations may be performed in parallel or in any suitable order. While at times discussed as the system 100, autonomous vehicle 502, control device 550, AFN management device 150, or components of any of thereof performing operations, any suitable system or components of the system may perform one or more operations of the method 300. For example, one or more operations of method 300 may be implemented, at least in part, in the form of software instructions 128, 160, and processing instructions 580, respectively, from FIGS. 1 and 5, stored on non-transitory, tangible, machine-readable media (e.g., memory 126, memory 158, and data storage 590, respectively, from FIGS. 1 and 5) that when run by one or more processors (e.g., processors 122, 152, and 570, respectively, from FIGS. 1 and 5) may cause the one or more processors to perform operations 302-314.

At 302, the AFN management device 150 receives information that indicates an autonomous vehicle 502 is inbound to a terminal 140. For example, the AFN management device 150 may receive sensor data 130 from sensors 546 of the autonomous vehicle 502 that include the GPS location coordinates and trajectory of the autonomous vehicle 502. Based on the sensor data 130, the AFN management device 150 may determine that the autonomous vehicle 502 is inbound to the terminal 140.

At 304, the AFN management device 150 receives sensor data indicating locations of objects within the terminal 140. For example, the AFN management device 150 may receive landing pad sensor signals 212 that indicate the locations of objects along a traveling path of the autonomous vehicle 502 to the landing pads 142a, similar to that described in FIG. 2.

At 306, the AFN management device 150 selects a landing pad 142a. The AFN management device 150 may iteratively select a landing pad 142a until no landing pad 142a is left for evaluation. For example, assume that the AFN management device 150 selects landing pad 142a-1.

At 308, the AFN management device 150 determines whether the landing pad 142a-1 is available to receive the autonomous vehicle 502. If it is determined that the landing pad 142a-1 is available to receive the autonomous vehicle 502, method 300 proceeds to 310. Otherwise, method 300 returns to 306. The AFN management device 150 may determine that the landing pad 142a-1 is available to receive the autonomous vehicle 502, if the landing pad 142a-1 is free of objects, similar to that described in FIG. 2.

At 310, the AFN management device 150 determines the locations of objects that are in a traveling path of the autonomous vehicle 502 to the landing pad 142a-1. In this process, the AFN management device 150 may use the landing pad sensor signals 212, similar to that described in FIG. 2.

At 312, the AFN management device 150 may determine landing instructions 162 that comprise the locations of objects in the traveling path of the autonomous vehicle 502 to the landing pad 142a-1. The landing instructions 162 may indicate to avoid the locations of objects in the traveling path toward the landing pad 142a-1, similar to that described in FIG. 2.

At 314, the AFN management device 150 may communicate the landing instructions 162 to the autonomous vehicle 502. The control device 550 may receive the landing instructions 162. The control device 550 may determine a route 230 for the autonomous vehicle 502 to take in order to reach the landing pad 142a-1, and instruct the autonomous vehicle 502 to travel according to the route 230, similar to that described in FIG. 2.

In certain embodiments, the AFN management device 150 may determine the route 230 based on the landing pad sensor signals 212 and sensor data 130, similar to that described in FIG. 2. In certain embodiments, the control device 550 may determine the route 230 based on the landing pad sensor signals 212 and sensor data 130, similar to that described in FIG. 2.

### Example Method for Outbound Operation

FIG. 4 illustrates an example flowchart of a method 400 for implementing an outbound operation for an outgoing autonomous vehicle 502 from a terminal 140. Modifications, additions, or omissions may be made to method 400. Method 400 may include more, fewer, or other operations. For example, operations may be performed in parallel or in any suitable order. While at times discussed as the system 100, autonomous vehicle 502, control device 550, AFN management device 150, or components of any of thereof performing operations, any suitable system or components of the system may perform one or more operations of the method 400. For example, one or more operations of method 400 may be implemented, at least in part, in the form of software instructions 128, software instructions 160, and processing instructions 580, respectively, from FIGS. 1 and 5, stored on non-transitory, tangible, machine-readable media (e.g., memory 126, memory 158, and data storage 590, respectively, from FIGS. 1 and 5) that when run by one or more processors (e.g., processors 122, 152, and 570, respectively, from FIGS. 1 and 5 may cause the one or more processors to perform operations 402-422.

At 402, the AFN management device 150 receives information that indicates an autonomous vehicle 502 is outbound from a terminal 140. For example, the AFN management device 150 may receive a message from a remote operator 180 that indicates the autonomous vehicle 502 is outbound from the terminal 140.

At 404, the AFN management device 150 accesses a trip 170 that is scheduled for the autonomous vehicle 502. The trip 170 may be provided by the remote operator 180.

At 406, the AFN management device 150 may identify a trailer that carries a load for the trip 170. For example, the trip 170 may include a load ID, trailer ID, lot ID where the trailer is located in the trailer staging zone 142b, a start location, a departure time window, arrival time window, a destination, a tractor ID, and other information.

At 408, the AFN management device 150 selects a launch pad 142h. The AFN management device 150 may iteratively select a launch pad 142h until no launch pad 142h is left for evaluation. For example, assume that the AFN management device 150 selects launch pad 142h-1.

At 410, the AFN management device 150 determines whether the launch pad 142h-1 is available to receive the autonomous vehicle 502. If it is determined that the launch pad 142h-1 is available to receive the autonomous vehicle 502, method 400 proceeds to 412. Otherwise, method 400 returns to 408. The AFN management device 150 may determine that the launch pad 142h-1 is available to receive the autonomous vehicle 502 if the launch pad 142h-1 is free of obstructions, similar to that described in FIG. 2.

At 412, the AFN management device 150 determines that the trailer and a tractor associated with the autonomous vehicle 502 are moved to the launch pad 142h-1. For example, the AFN management device 150 may receive messages from computing devices (e.g., computing device 104a and/or 120b) associated with drivers (e.g., users 102a and/or 102b) that indicate the trailer and tractor are moved to the launch pad 142h-1, similar to that described in FIG. 2.

At 414, the AFN management device 150 determines that the trailer is attached to the tractor. For example, the AFN management device 150 may receive a message from a computing device (e.g., computing device 104a or 120b) associated with a technician (e.g., user 102a or 102b) that indicates that the trailer is attached to the tractor, similar to that described in FIG. 2.

At 416, the AFN management device 150 determines that a pre-trip inspection 234 is performed on the autonomous vehicle 502. For example, the AFN management device 150 may receive a message from a computing device (e.g., computing device 104b) associated with the user 102b that indicates the pre-trip inspection 234 is performed on the autonomous vehicle 502, similar to that described in FIG. 2.

At 418, the AFN management device 150 receives sensor data indicating locations of objects in a traveling path of the autonomous vehicle 502 from the launch pad 142h-1 to exit the terminal 140. For example, the AFN management device 150 may receive launch pad sensor signals 218 from sensors 146 associated with the launch pads 142h, similar to that described in FIG. 2.

At 420, the AFN management device 150 determines launching instructions 166 that comprises the locations of objects in the traveling path of the autonomous vehicle 502 from the launch pad 142h-1 to exit the terminal 140. The launching instructions 166 may indicate to avoid the locations of objects. The launching instructions 166 may include an outbound lane 206 for the autonomous vehicle 502 to take to exit the terminal 140.

At 422, the AFN management device 150 communicates the launching instructions 166 to the autonomous vehicle 502. The control device 550 receives the launching instructions 166. The control device 550 may determine a route 240 for the autonomous vehicle 502 to take in order to exit the terminal 140 and start the trip 170, similar to that described in FIG. 2.

In certain embodiments, the AFN management device 150 may determine the route 240 based on the launch pad sensor signals 218 and sensor data 130, similar to that described in FIG. 2. In certain embodiments, the control device 550 may determine the route 240 based on the launch pad sensor signals 218 and sensor data 130, similar to that described in FIG. 2.

### Example Autonomous Vehicle and its Operation

FIG. 5 shows a block diagram of an example vehicle ecosystem 500 in which autonomous driving operations can be determined. As shown in FIG. 5, the autonomous vehicle 502 may be a semi-trailer truck. The vehicle ecosystem 500 may include several systems and components that can generate and/or deliver one or more sources of information/data and related services to the in-vehicle control computer 550 that may be located in an autonomous vehicle 502. The in-vehicle control computer 550 can be in data communication with a plurality of vehicle subsystems 540, all of which can be resident in the autonomous vehicle 502. A vehicle subsystem interface 560 may be provided to facilitate data communication between the in-vehicle control computer 550 and the plurality of vehicle subsystems 540. In some embodiments, the vehicle subsystem interface 560 can include a controller area network (CAN) controller to communicate with devices in the vehicle subsystems 540.

The autonomous vehicle 502 may include various vehicle subsystems that support the operation of the autonomous vehicle 502. The vehicle subsystems 540 may include a vehicle drive subsystem 542, a vehicle sensor subsystem 544, a vehicle control subsystem 548, and/or network communication subsystem 592. The components or devices of the vehicle drive subsystem 542, the vehicle sensor subsystem 544, and the vehicle control subsystem 548 shown in FIG. 5 are examples. The autonomous vehicle 502 may be configured as shown or any other configurations.

The vehicle drive subsystem 542 may include components operable to provide powered motion for the autonomous vehicle 502. In an example embodiment, the vehicle drive subsystem 542 may include an engine/motor 542a, wheels/tires 542b, a transmission 542c, an electrical subsystem 542d, and a power source 542e.

The vehicle sensor subsystem 544 may include a number of sensors 546 configured to sense information about an environment or condition of the autonomous vehicle 502. The vehicle sensor subsystem 544 may include one or more cameras 546a or image capture devices, a radar unit 546b, one or more temperature sensors 546c, a wireless communication unit 546d (e.g., a cellular communication transceiver), an inertial measurement unit (IMU) 546e, a laser range finder/LiDAR unit 546f, a Global Positioning System (GPS) transceiver 546g, a wiper control system 546h. The vehicle sensor subsystem 544 may also include sensors configured to monitor internal systems of the autonomous vehicle 502 (e.g., an 02 monitor, a fuel gauge, an engine oil temperature, etc.).

The IMU 546e may include any combination of sensors (e.g., accelerometers and gyroscopes) configured to sense position and orientation changes of the autonomous vehicle 502 based on inertial acceleration. The GPS transceiver 546g may be any sensor configured to estimate a geographic location of the autonomous vehicle 502. For this purpose, the GPS transceiver 546g may include a receiver/transmitter operable to provide information regarding the position of the autonomous vehicle 502 with respect to the Earth. The radar unit 546b may represent a system that utilizes radio signals to sense objects within the local environment of the autonomous vehicle 502. In some embodiments, in addition to sensing the objects, the radar unit 546b may additionally be configured to sense the speed and the heading of the objects proximate to the autonomous vehicle 502. The laser range finder or LiDAR unit 546f may be any sensor configured to use lasers to sense objects in the environment in which the autonomous vehicle 502 is located. The cameras 546a may include one or more devices configured to capture a plurality of images of the environment of the autonomous vehicle 502. The cameras 546a may be still image cameras or motion video cameras.

The vehicle control subsystem 548 may be configured to control the operation of the autonomous vehicle 502 and its components. Accordingly, the vehicle control subsystem 548 may include various elements such as a throttle and gear selector 548a, a brake unit 548b, a navigation unit 548c, a steering system 548d, and/or an autonomous control unit 548e. The throttle and gear selector 548a may be configured to control, for instance, the operating speed of the engine and, in turn, control the speed of the autonomous vehicle 502. The throttle and gear selector 548a may be configured to control the gear selection of the transmission. The brake unit 548b can include any combination of mechanisms configured to decelerate the autonomous vehicle 502. The brake unit 548b can slow the autonomous vehicle 502 in a standard manner, including by using friction to slow the wheels or engine braking. The brake unit 548b may include an anti-lock brake system (ABS) that can prevent the brakes from locking up when the brakes are applied. The navigation unit 548c may be any system configured to determine a driving path or route for the autonomous vehicle 502. The navigation unit 548c may additionally be configured to update the driving path dynamically while the autonomous vehicle 502 is in operation. In some embodiments, the navigation unit 548c may be configured to incorporate data from the GPS transceiver 546g and one or more predetermined maps so as to determine the driving path for the autonomous vehicle 502. The steering system 548d may represent any combination of mechanisms that may be operable to adjust the heading of autonomous vehicle 502 in an autonomous mode or in a driver-controlled mode.

The autonomous control unit 548e may represent a control system configured to identify, evaluate, and avoid or otherwise negotiate potential obstacles or obstructions in the environment of the autonomous vehicle 502. In general, the autonomous control unit 548e may be configured to control the autonomous vehicle 502 for operation without a driver or to provide driver assistance in controlling the autonomous vehicle 502. In some embodiments, the autonomous control unit 548e may be configured to incorporate data from the GPS transceiver 546g, the radar unit 546b, the LiDAR unit 546f, the cameras 546a, and/or other vehicle subsystems to determine the driving path or trajectory for the autonomous vehicle 502.

The network communication subsystem 592 may comprise network interfaces, such as routers, switches, modems, and/or the like. The network communication subsystem 592 may be configured to establish communication between the autonomous vehicle 502 and other systems, servers, etc. The network communication subsystem 592 may be further configured to send and receive data from and to other systems.

Many or all of the functions of the autonomous vehicle 502 can be controlled by the in-vehicle control computer 550. The in-vehicle control computer 550 may include at least one data processor 570 (which can include at least one microprocessor) that executes processing instructions 580 stored in a non-transitory computer-readable medium, such as the data storage device 590 or memory. The in-vehicle control computer 550 may also represent a plurality of computing devices that may serve to control individual components or subsystems of the autonomous vehicle 502 in a distributed fashion. In some embodiments, the data storage device 590 may contain processing instructions 580 (e.g., program logic) executable by the data processor 570 to perform various methods and/or functions of the autonomous vehicle 502, including those described with respect to FIGS. 1-7.

The data storage device 590 may contain additional instructions as well, including instructions to transmit data to, receive data from, interact with, or control one or more of the vehicle drive subsystem 542, the vehicle sensor subsystem 544, and the vehicle control subsystem 548. The in-vehicle control computer 550 can be configured to include a data processor 570 and a data storage device 590. The in-vehicle control computer 550 may control the function of the autonomous vehicle 502 based on inputs received from various vehicle subsystems (e.g., the vehicle drive subsystem 542, the vehicle sensor subsystem 544, and the vehicle control subsystem 548).

FIG. 6 shows an exemplary system 600 for providing precise autonomous driving operations. The system 600 may include several modules that can operate in the in-vehicle control computer 550, as described in FIG. 5. The in-vehicle control computer 550 may include a sensor fusion module 602 shown in the top left corner of FIG. 6, where the sensor fusion module 602 may perform at least four image or signal processing operations. The sensor fusion module 602 can obtain images from cameras located on an autonomous vehicle to perform image segmentation 604 to detect the presence of moving objects (e.g., other vehicles, pedestrians, etc.,) and/or static obstacles (e.g., stop sign, speed bump, terrain, etc.,) located around the autonomous vehicle. The sensor fusion module 602 can obtain LiDAR point cloud data item from LiDAR sensors located on the autonomous vehicle to perform LiDAR segmentation 606 to detect the presence of objects and/or obstacles located around the autonomous vehicle.

The sensor fusion module 602 can perform instance segmentation 608 on image and/or point cloud data items to identify an outline (e.g., boxes) around the objects and/or obstacles located around the autonomous vehicle. The sensor fusion module 602 can perform temporal fusion 610 where objects and/or obstacles from one image and/or one frame of point cloud data item are correlated with or associated with objects and/or obstacles from one or more images or frames subsequently received in time.

The sensor fusion module 602 can fuse the objects and/or obstacles from the images obtained from the camera and/or point cloud data item obtained from the LiDAR sensors. For example, the sensor fusion module 602 may determine based on a location of two cameras that an image from one of the cameras comprising one half of a vehicle located in front of the autonomous vehicle is the same as the vehicle captured by another camera. The sensor fusion module 602 may send the fused object information to the interference module 646 and the fused obstacle information to the occupancy grid module 660. The in-vehicle control computer may include the occupancy grid module 660 which can retrieve landmarks from a map database 658 stored in the in-vehicle control computer. The occupancy grid module 660 can determine drivable areas and/or obstacles from the fused obstacles obtained from the sensor fusion module 602 and the landmarks stored in the map database 658. For example, the occupancy grid module 660 can determine that a drivable area may include a speed bump obstacle.

Below the sensor fusion module 602, the in-vehicle control computer 550 may include a LiDAR-based object detection module 612 that can perform object detection 616 based on point cloud data item obtained from the LiDAR sensors 614 located on the autonomous vehicle. The object detection 616 technique can provide a location (e.g., in 3D world coordinates) of objects from the point cloud data item. Below the LiDAR-based object detection module 612, the in-vehicle control computer may include an image-based object detection module 618 that can perform object detection 624 based on images obtained from cameras 620 located on the autonomous vehicle. The object detection 618 technique can employ a deep machine learning technique 624 to provide a location (e.g., in 3D world coordinates) of objects from the image provided by the camera 620.

The radar 656 on the autonomous vehicle can scan an area in front of the autonomous vehicle or an area towards which the autonomous vehicle is driven. The radar data may be sent to the sensor fusion module 602 that can use the radar data to correlate the objects and/or obstacles detected by the radar 656 with the objects and/or obstacles detected from both the LiDAR point cloud data item and the camera image. The radar data also may be sent to the interference module 646 that can perform data processing on the radar data to track objects by object tracking module 648 as further described below.

The in-vehicle control computer may include an interference module 646 that receives the locations of the objects from the point cloud and the objects from the image, and the fused objects from the sensor fusion module 602. The interference module 646 also receives the radar data with which the interference module 646 can track objects by object tracking module 648 from one point cloud data item and one image obtained at one time instance to another (or the next) point cloud data item and another image obtained at another subsequent time instance.

The interference module 646 may perform object attribute estimation 650 to estimate one or more attributes of an object detected in an image or point cloud data item. The one or more attributes of the object may include a type of object (e.g., pedestrian, car, or truck, etc.). The interference module 646 may perform behavior prediction 652 to estimate or predict the motion pattern of an object detected in an image and/or a point cloud. The behavior prediction 652 can be performed to detect a location of an object in a set of images received at different points in time (e.g., sequential images) or in a set of point cloud data items received at different points in time (e.g., sequential point cloud data items). In some embodiments, the behavior prediction 652 can be performed for each image received from a camera and/or each point cloud data item received from the LiDAR sensor. In some embodiments, the interference module 646 can be performed (e.g., run or executed) to reduce computational load by performing behavior prediction 652 on every other or after every pre-determined number of images received from a camera or point cloud data item received from the LiDAR sensor (e.g., after every two images or after every three-point cloud data items).

The behavior prediction 652 feature may determine the speed and direction of the objects that surround the autonomous vehicle from the radar data, where the speed and direction information can be used to predict or determine motion patterns of objects. A motion pattern may comprise a predicted trajectory information of an object over a pre-determined length of time in the future after an image is received from a camera. Based on the motion pattern predicted, the interference module 646 may assign motion pattern situational tags to the objects (e.g., “located at coordinates (x,y),” “stopped,” “driving at 50 mph,” “speeding up” or “slowing down”). The situation tags can describe the motion pattern of the object. The interference module 646 may send the one or more object attributes (e.g., types of the objects) and motion pattern situational tags to the planning module 662. The interference module 646 may perform an environment analysis 654 using any information acquired by system 600 and any number and combination of its components.

The in-vehicle control computer may include the planning module 662 that receives the object attributes and motion pattern situational tags from the interference module 646, the drivable area and/or obstacles, and the vehicle location and pose information from the fused localization module 626 (further described below).

The planning module 662 can perform navigation planning 664 to determine a set of trajectories on which the autonomous vehicle can be driven. The set of trajectories can be determined based on the drivable area information, the one or more object attributes of objects, the motion pattern situational tags of the objects, location of the obstacles, and the drivable area information. In some embodiments, the navigation planning 664 may include determining an area next to the road where the autonomous vehicle can be safely parked in case of emergencies. The planning module 662 may include behavioral decision making 666 to determine driving actions (e.g., steering, braking, throttle) in response to determining changing conditions on the road (e.g., traffic light turned yellow, or the autonomous vehicle is in an unsafe driving condition because another vehicle drove in front of the autonomous vehicle and in a region within a pre-determined safe distance of the location of the autonomous vehicle). The planning module 662 performs trajectory generation 668 and selects a trajectory from the set of trajectories determined by the navigation planning operation 664. The selected trajectory information may be sent by the planning module 662 to the control module 670.

The in-vehicle control computer may include a control module 670 that receives the proposed trajectory from the planning module 662 and the autonomous vehicle location and pose from the fused localization module 626. The control module 670 may include a system identifier 672. The control module 670 can perform a model-based trajectory refinement 674 to refine the proposed trajectory. For example, the control module 670 can apply filtering (e.g., Kalman filter) to make the proposed trajectory data smooth and/or to minimize noise. The control module 670 may perform the robust control 676 by determining, based on the refined proposed trajectory information and current location and/or pose of the autonomous vehicle, an amount of brake pressure to apply, a steering angle, a throttle amount to control the speed of the vehicle, and/or a transmission gear. The control module 670 can send the determined brake pressure, steering angle, throttle amount, and/or transmission gear to one or more devices in the autonomous vehicle to control and facilitate precise driving operations of the autonomous vehicle.

The deep image-based object detection 624 performed by the image-based object detection module 618 can also be used detect landmarks (e.g., stop signs, speed bumps, etc.,) on the road. The in-vehicle control computer may include a fused localization module 626 that obtains landmarks detected from images, the landmarks obtained from a map database 636 stored on the in-vehicle control computer, the landmarks detected from the point cloud data item by the LiDAR-based object detection module 612, the speed and displacement from the odometer sensor 644, or a rotary encoder, and the estimated location of the autonomous vehicle from the GPS/IMU sensor 638 (i.e., GPS sensor 640 and IMU sensor 642) located on or in the autonomous vehicle. Based on this information, the fused localization module 626 can perform a localization operation 628 to determine a location of the autonomous vehicle, which can be sent to the planning module 662 and the control module 670.

The fused localization module 626 can estimate pose 630 of the autonomous vehicle based on the GPS and/or IMU sensors 638. The pose of the autonomous vehicle can be sent to the planning module 662 and the control module 670. The fused localization module 626 can also estimate status (e.g., location, possible angle of movement) of the trailer unit based on (e.g., trailer status estimation 634), for example, the information provided by the IMU sensor 642 (e.g., angular rate and/or linear velocity). The fused localization module 626 may also check the map content 632.

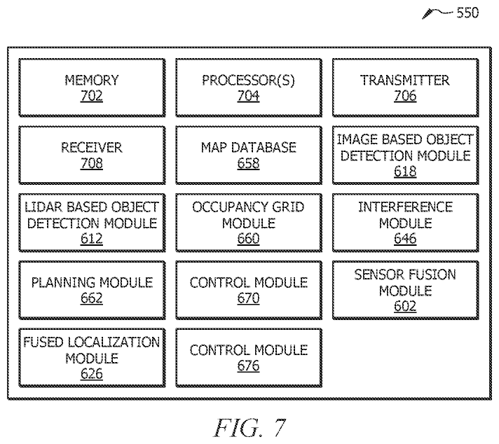

FIG. 7 shows an exemplary block diagram of an in-vehicle control computer 550 included in an autonomous vehicle 502. The in-vehicle control computer 550 may include at least one processor 704 and a memory 702 having instructions stored thereupon (e.g., software instructions 128 and processing instructions 580 in FIGS. 1 and 5, respectively). The instructions, upon execution by the processor 704, configure the in-vehicle control computer 550 and/or the various modules of the in-vehicle control computer 550 to perform the operations described in FIGS. 1-7. The transmitter 706 may transmit or send information or data to one or more devices in the autonomous vehicle. For example, the transmitter 706 can send an instruction to one or more motors of the steering wheel to steer the autonomous vehicle. The receiver 708 receives information or data transmitted or sent by one or more devices. For example, the receiver 708 receives a status of the current speed from the odometer sensor or the current transmission gear from the transmission. The transmitter 706 and receiver 708 also may be configured to communicate with the plurality of vehicle subsystems 540 and the in-vehicle control computer 550 described above in FIGS. 5 and 6.

While several embodiments have been provided in this disclosure, it should be understood that the disclosed systems and methods might be embodied in many other specific forms without departing from the spirit or scope of this disclosure. The present examples are to be considered as illustrative and not restrictive, and the intention is not to be limited to the details given herein. For example, the various elements or components may be combined or integrated into another system or certain features may be omitted, or not implemented.

In addition, techniques, systems, subsystems, and methods described and illustrated in the various embodiments as discrete or separate may be combined or integrated with other systems, modules, techniques, or methods without departing from the scope of this disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

Implementations of the disclosure can be described in view of the following clauses, the features of which can be combined in any reasonable manner.

Clause 1. An autonomous vehicle inbound and outbound management system comprising:
a fleet of autonomous vehicles comprising a first autonomous vehicle, wherein the first autonomous vehicle is configured to travel along a predetermined route;
a terminal comprising one or more dedicated zones and one or more sensors within a physical space, wherein:
each of the one or more dedicated zones is configured to facilitate a particular function for the first autonomous vehicle;
the one or more dedicated zones comprise a landing pad shaped to accommodate the first autonomous vehicle;
the landing pad is established by a set of boundary indicators disposed around the landing pad; and
each of the one or more sensors is configured to detect objects within a detection range;
an autonomous freight network management device operably coupled with the fleet of autonomous vehicles, and comprising a first processor configured to:
receive information that indicates the first autonomous vehicle is inbound to the terminal;
receive first sensor data indicating locations of objects within the terminal;
determine, based at least in part upon the first sensor data, at least one location of at least one object that is in a traveling path of the first autonomous vehicle to the landing pad;
determine landing instructions that comprise the at least one location of at least one object, wherein the landing instructions indicate to avoid the at least one location of at least one object;
communicate the landing instructions to the first autonomous vehicle;
wherein the first autonomous vehicle comprises a control device that comprises a second processor configured to:
receive the landing instructions;
determine, based at least in part upon the landing instructions, a first route for the first autonomous vehicle to take in order to reach the landing pad, wherein the first route is free of the at least one object; and
instruct the first autonomous vehicle to travel according to the first route.

Clause 2. The system of Clause 1, wherein prior to determining the landing instructions to reach the landing pad, the first processor is further configured to determine whether the landing pad is occupied by a second autonomous vehicle or any object that prevents the first autonomous vehicle from landing inside the landing pad.

Clause 3. The system of Clause 2, wherein determining the landing instructions is in response to determining that the landing pad is not occupied by the second autonomous vehicle or any object that prevents the first autonomous vehicle from landing inside the landing pad.

Clause 4. The system of Clause 1, wherein:
the second processor is configured to receive second sensor data from at least one sensor associated with the first autonomous vehicle, wherein the second sensor data comprises locations of objects detected by the at least one sensor; and
determining the first route is further based at least in part upon the second sensor data.

Clause 5. The system of Clause 4, wherein instructing the first autonomous vehicle to travel according to the first route comprises:
determining whether the set of boundary indicators associated with the landing pad are detected in the second sensor data; and
in response to determining that the set of boundary indicators are indicated in the second sensor data, instructing the first autonomous vehicle to travel into the landing pad until a particular distance from the set of boundary indicators.

Clause 6. The system of Clause 1, wherein the first autonomous vehicle is a tractor attached to a trailer.

Clause 7. The system of Clause 2, wherein the first processor is further configured to, in response to determining that the landing pad is occupied by the second autonomous vehicle or any object that prevents the first autonomous vehicle from landing inside the landing pad:
identify another landing pad;
determine updated landing instructions that comprise a second route to the other landing pad; and
communicate the updated landing instructions to the first autonomous vehicle.

Clause 8. The system of Clause 6, wherein the first processor is further configured to:
determine that a post-trip inspection is performed on the first autonomous vehicle;
determine a drop off zone to drop off the trailer, wherein:
the drop off zone is configured to facilitate trailer drop offs; and
the drop off zone is one of the one or more dedicated zones;
communicate the drop off zone to a computing device associated with a driver of a vehicle that is configured to move the trailer; and
receive, from the computing device, a confirmation that indicates the trailer is moved to the drop off zone.

Clause 9. The system of Clause 1, wherein the first processor is further configured to:
determine that a post-trip inspection is performed on the first autonomous vehicle;
determine, based at least in part upon the post-trip inspection, that at least one of map data and autonomy software code associated with the first autonomous vehicle needs to be updated;
determine a data communication zone; wherein:
the data communication zone is configured to facilitate communicating the at least one of map data and autonomy software code to the first autonomous vehicle;
the data communication zone is one of the one or more dedicated zones;
communicate the data communication zone to a computing device associated with a driver;
receive, from the computing device, a confirmation that indicates the first autonomous vehicle is moved to the data communication zone; and
communicate at least one of updated map data and updated autonomy software code to the first autonomous vehicle.

Clause 10. The system of Clause 9, wherein:
the map data comprises routes and location coordinates of objects on the routes within a traveling range of the first autonomous vehicle; and
the autonomy software code facilitates autonomous functions of the first autonomous vehicle.

Clause 11. The system of Clause 1, wherein the first processor is further configured to:
determine that a post-trip inspection is performed on the first autonomous vehicle;
determine, based at least in part upon the post-trip inspection, that the first autonomous vehicle requires a service;
determine a service zone, wherein:
the service zone is configured to facilitate the service to be provided to the first autonomous vehicle; and
the service zone is one of the one or more dedicated zones;
communicate the service zone to a computing device associated with a driver; and
receive, from the computing device, a confirmation that indicates the first autonomous vehicle is moved to the service zone.

Clause 12. The system of Clause 11, wherein the service comprises at least one of sensor calibration, sensor housing cleaning, fuel refilling, oil refilling, tire air refilling, and cooling fluid refilling.

Clause 13. The system of Clause 1, wherein the first processor is further configured to:
determine that a post-trip inspection is performed on the first autonomous vehicle, wherein the first autonomous vehicle comprises a tractor attached to a trailer;
determine, based at least in part upon the post-trip inspection, that the tractor is ready for a next trip;
determine a staging zone, wherein:
the staging zone is where the tractor is positioned to indicate that the tractor is ready for the next trip; and
the staging zone is one of the one or more dedicated zones; and
receive information, from a computing device associated with a driver, that indicates the tractor is moved to the staging zone.

Clause 14. The system of Clause 13, wherein determining that the post-trip inspection is performed is in response to receiving a message that indicates the post-trip inspection is performed from a computing device associated with an inspector.

Clause 15. An autonomous vehicle inbound and outbound management system comprising:
a fleet of autonomous vehicles comprising a first autonomous vehicle, wherein:
the first autonomous vehicle configured to travel along a predetermined route; and
the first autonomous vehicle comprises a tractor attached to a trailer;
a terminal comprising one or more dedicated zones and one or more sensors within a physical space, wherein:
each of the one or more dedicated zones is configured to facilitate a particular function for the first autonomous vehicle;
the one or more dedicated zones comprises a launch pad configured to accommodate the first autonomous vehicle;
the launch pad is established by a set of boundary indicators disposed around the launch pad;
the launch pad is a location where a pre-trip inspection is performed on the first autonomous vehicle; and
each of the one or more sensors is configured to detect objects within a detection range;
an autonomous freight network management device operably coupled with the fleet of autonomous vehicles, and comprising a first processor configured to:
receive information that indicates the first autonomous vehicle is outbound from the terminal;
access a trip that is scheduled for the first autonomous vehicle, wherein the trip indicates at least one of a start location, a load, a departure time, an arrival time, and a destination;
identify the trailer that carries the load for the trip;
determine that the trailer is moved to the launch pad;
determine that the tractor is moved to the launch pad;
determine that the tractor is attached to the trailer at the launch pad;
determine that the pre-trip inspection is complete, wherein the pre-trip inspection comprises communicating the trip to the first autonomous vehicle and determining that health levels associated with components of the first autonomous vehicle are more than a threshold percentage;
receive sensor data indicating locations of objects within the terminal;
determine, based at least in part upon the sensor data, at least one location of at least one object that is in a traveling path of the first autonomous vehicle from the launch pad to exit the terminal;
determine launching instructions that comprise the at least one location of at least one object, wherein the launching instructions indicate to avoid the at least one location of at least one object; and
communicate the launching instructions to the first autonomous vehicle;
wherein the first autonomous vehicle comprises a control device that comprises a second processor configured to:
receive the launching instructions;
determine, based at least in part upon the launching instructions, a first route for the first autonomous vehicle to take in order to exit the terminal and start the trip, wherein the first route is free of the at least one object; and
instruct the first autonomous vehicle to travel according to the first route.

Clause 16. The system of Clause 15, wherein prior to determining the launching instructions, the first processor is further configured to determine whether the launch pad is occupied by a second autonomous vehicle or any object that prevents the first autonomous vehicle from landing inside the launch pad.

Clause 17. The system of Clause 16, wherein determining the launching instructions is in response to determining that the launch pad is not occupied by the second autonomous vehicle or any object that prevents the first autonomous vehicle from landing inside the launch pad.

Clause 18. The system of Clause 15, wherein
the second processor is configured to receive second sensor data from at least one sensor associated with the first autonomous vehicle, wherein the second sensor data comprises locations of objects detected by the at least one sensor; and
determining the first route is further based at least in part upon the second sensor data.

Clause 19. The system of Clause 15, wherein the one or more sensors comprise a camera sensor, a light detection and ranging (LiDAR) sensor, and an infrared sensor.

Clause 20. The system of Clause 16, wherein the first processor is further configured to, in response to determining that the launch pad is occupied by the second autonomous vehicle or any object that prevents the first autonomous vehicle from landing inside the launch pad:
identify another launch pad;
determine updated launching instructions that comprise a second route to the other launch pad; and
communicate the updated launching instructions to the first autonomous vehicle.

Clause 21. A method comprising one or more operations according to any of Clauses 1-14.

Clause 22. A method comprising one or more operations according to any of Clauses 15-20.

Clause 23. An apparatus comprising means for performing one or more operations according to any of Clauses 1-20.

Clause 24. A non-transitory computer-readable medium storing instructions that when executed by one or more processors cause the one or more processors to perform one or more operations according to any of Clauses 1-14.

Clause 25. A non-transitory computer-readable medium storing instructions that when executed by one or more processors cause the one or more processors to perform one or more operations according to any of Clauses 15-20

1. An autonomous vehicle inbound and outbound management system comprising:
a fleet of autonomous vehicles comprising a first autonomous vehicle, wherein the first autonomous vehicle is configured to travel along a predetermined route;
a terminal comprising one or more dedicated zones and one or more sensors within a physical space, wherein:
each of the one or more dedicated zones is configured to facilitate a particular function for the first autonomous vehicle;
the one or more dedicated zones comprise a landing pad shaped to accommodate the first autonomous vehicle;
the landing pad is established by a set of boundary indicators disposed around the landing pad; and
each of the one or more sensors is configured to detect objects within a detection range;
an autonomous freight network management device operably coupled with the fleet of autonomous vehicles, and comprising a first processor configured to:
receive information that indicates the first autonomous vehicle is inbound to the terminal;
receive first sensor data indicating locations of objects within the terminal;
determine, based at least in part upon the first sensor data, at least one location of at least one object that is in a traveling path of the first autonomous vehicle to the landing pad;
determine landing instructions that comprise the at least one location of at least one object, wherein the landing instructions indicate to avoid the at least one location of at least one object;
communicate the landing instructions to the first autonomous vehicle;
wherein the first autonomous vehicle comprises a control device that comprises a second processor configured to:
receive the landing instructions;
determine, based at least in part upon the landing instructions, a first route for the first autonomous vehicle to take in order to reach the landing pad, wherein the first route is free of the at least one object; and
instruct the first autonomous vehicle to travel according to the first route.

2. The system of claim 1, wherein prior to determining the landing instructions to reach the landing pad, the first processor is further configured to determine whether the landing pad is occupied by a second autonomous vehicle or any object that prevents the first autonomous vehicle from landing inside the landing pad.

3. The system of claim 2, wherein determining the landing instructions is in response to determining that the landing pad is not occupied by the second autonomous vehicle or any object that prevents the first autonomous vehicle from landing inside the landing pad.

4. The system of claim 1, wherein:
the second processor is configured to receive second sensor data from at least one sensor associated with the first autonomous vehicle, wherein the second sensor data comprises locations of objects detected by the at least one sensor; and
determining the first route is further based at least in part upon the second sensor data.

5. The system of claim 4, wherein instructing the first autonomous vehicle to travel according to the first route comprises:
determining whether the set of boundary indicators associated with the landing pad are detected in the second sensor data; and
in response to determining that the set of boundary indicators are indicated in the second sensor data, instructing the first autonomous vehicle to travel into the landing pad until a particular distance from the set of boundary indicators.

6. The system of claim 1, wherein the first autonomous vehicle is a tractor attached to a trailer.

7. The system of claim 2, wherein the first processor is further configured to, in response to determining that the landing pad is occupied by the second autonomous vehicle or any object that prevents the first autonomous vehicle from landing inside the landing pad:
identify another landing pad;
determine updated landing instructions that comprise a second route to the other landing pad; and
communicate the updated landing instructions to the first autonomous vehicle.

8. The system of claim 6, wherein the first processor is further configured to:
determine that a post-trip inspection is performed on the first autonomous vehicle;
determine a drop off zone to drop off the trailer, wherein:
the drop off zone is configured to facilitate trailer drop offs; and
the drop off zone is one of the one or more dedicated zones;
communicate the drop off zone to a computing device associated with a driver of a vehicle that is configured to move the trailer; and
receive, from the computing device, a confirmation that indicates the trailer is moved to the drop off zone.

9. The system of claim 1, wherein the first processor is further configured to:
determine that a post-trip inspection is performed on the first autonomous vehicle;
determine, based at least in part upon the post-trip inspection, that at least one of map data and autonomy software code associated with the first autonomous vehicle needs to be updated;
determine a data communication zone; wherein:
the data communication zone is configured to facilitate communicating the at least one of map data and autonomy software code to the first autonomous vehicle;
the data communication zone is one of the one or more dedicated zones;
communicate the data communication zone to a computing device associated with a driver;
receive, from the computing device, a confirmation that indicates the first autonomous vehicle is moved to the data communication zone; and
communicate at least one of updated map data and updated autonomy software code to the first autonomous vehicle.

10. The system of claim 9, wherein:
the map data comprises routes and location coordinates of objects on the routes within a traveling range of the first autonomous vehicle; and
the autonomy software code facilitates autonomous functions of the first autonomous vehicle.

11. The system of claim 1, wherein the first processor is further configured to:
determine that a post-trip inspection is performed on the first autonomous vehicle;
determine, based at least in part upon the post-trip inspection, that the first autonomous vehicle requires a service;
determine a service zone, wherein:
the service zone is configured to facilitate the service to be provided to the first autonomous vehicle; and
the service zone is one of the one or more dedicated zones;
communicate the service zone to a computing device associated with a driver; and
receive, from the computing device, a confirmation that indicates the first autonomous vehicle is moved to the service zone.

12. The system of claim 11, wherein the service comprises at least one of sensor calibration, sensor housing cleaning, fuel refilling, oil refilling, tire air refilling, and cooling fluid refilling.

13. The system of claim 1, wherein the first processor is further configured to:
determine that a post-trip inspection is performed on the first autonomous vehicle, wherein the first autonomous vehicle comprises a tractor attached to a trailer;
determine, based at least in part upon the post-trip inspection, that the tractor is ready for a next trip;
determine a staging zone, wherein:
the staging zone is where the tractor is positioned to indicate that the tractor is ready for the next trip; and
the staging zone is one of the one or more dedicated zones; and
receive information, from a computing device associated with a driver, that indicates the tractor is moved to the staging zone.

14. The system of claim 13, wherein determining that the post-trip inspection is performed is in response to receiving a message that indicates the post-trip inspection is performed from a computing device associated with an inspector.

15. An autonomous vehicle inbound and outbound management system comprising:
a fleet of autonomous vehicles comprising a first autonomous vehicle, wherein:
the first autonomous vehicle configured to travel along a predetermined route; and
the first autonomous vehicle comprises a tractor attached to a trailer;
a terminal comprising one or more dedicated zones and one or more sensors within a physical space, wherein:
each of the one or more dedicated zones is configured to facilitate a particular function for the first autonomous vehicle;
the one or more dedicated zones comprises a launch pad configured to accommodate the first autonomous vehicle;
the launch pad is established by a set of boundary indicators disposed around the launch pad;
the launch pad is a location where a pre-trip inspection is performed on the first autonomous vehicle; and
each of the one or more sensors is configured to detect objects within a detection range;
an autonomous freight network management device operably coupled with the fleet of autonomous vehicles, and comprising a first processor configured to:
receive information that indicates the first autonomous vehicle is outbound from the terminal;
access a trip that is scheduled for the first autonomous vehicle, wherein the trip indicates at least one of a start location, a load, a departure time, an arrival time, and a destination;
identify the trailer that carries the load for the trip;
determine that the trailer is moved to the launch pad;
determine that the tractor is moved to the launch pad;
determine that the tractor is attached to the trailer at the launch pad;
determine that the pre-trip inspection is complete, wherein the pre-trip inspection comprises communicating the trip to the first autonomous vehicle and determining that health levels associated with components of the first autonomous vehicle are more than a threshold percentage;
receive sensor data indicating locations of objects within the terminal;
determine, based at least in part upon the sensor data, at least one location of at least one object that is in a traveling path of the first autonomous vehicle from the launch pad to exit the terminal;
determine launching instructions that comprise the at least one location of at least one object, wherein the launching instructions indicate to avoid the at least one location of at least one object; and
communicate the launching instructions to the first autonomous vehicle;
wherein the first autonomous vehicle comprises a control device that comprises a second processor configured to:
receive the launching instructions;
determine, based at least in part upon the launching instructions, a first route for the first autonomous vehicle to take in order to exit the terminal and start the trip, wherein the first route is free of the at least one object; and
instruct the first autonomous vehicle to travel according to the first route.

16. The system of claim 15, wherein prior to determining the launching instructions, the first processor is further configured to determine whether the launch pad is occupied by a second autonomous vehicle or any object that prevents the first autonomous vehicle from landing inside the launch pad.

17. The system of claim 16, wherein determining the launching instructions is in response to determining that the launch pad is not occupied by the second autonomous vehicle or any object that prevents the first autonomous vehicle from landing inside the launch pad.

18. The system of claim 15, wherein:
the second processor is configured to receive second sensor data from at least one sensor associated with the first autonomous vehicle, wherein the second sensor data comprises locations of objects detected by the at least one sensor; and
determining the first route is further based at least in part upon the second sensor data.

19. The system of claim 15, wherein the one or more sensors comprise a camera sensor, a light detection and ranging (LiDAR) sensor, and an infrared sensor.

20. The system of claim 16, wherein the first processor is further configured to, in response to determining that the launch pad is occupied by the second autonomous vehicle or any object that prevents the first autonomous vehicle from landing inside the launch pad:
identify another launch pad;
determine updated launching instructions that comprise a second route to the other launch pad; and
communicate the updated launching instructions to the first autonomous vehicle.
